(19) United States
(12) Patent Application Publication
(10) Pub. No.: US 2023/0309081 A1
(43) Pub. Date: Sep. 28, 2023

(54) METHOD AND APPARATUS FOR MOBILE TERMINATED SMALL DATA TRANSMISSION IN A WIRELESS COMMUNICATION SYSTEM

(71) Applicant: ASUSTek Computer Inc., Taipei City 112 (TW)

(72) Inventors: Yi-Hsuan Huang, Taipei City (TW); Meng-Hui Ou, Taipei City (TW); Yu-Hsuan Guo, Taipei City (TW)

(21) Appl. No.: 18/109,117

(22) Filed: Feb. 13, 2023

Related U.S. Application Data
(60) Provisional application No. 63/323,916, filed on Mar. 25, 2022.

(51) Int. Cl. H04W 72/11; H04W 76/20; H04W 68/02; H04W 76/30

(52) U.S. Cl. CPC H04W 72/11; H04W 76/20; H04W 68/02; H04W 76/30

(57) ABSTRACT

Methods, systems, and apparatuses are provided for mobile terminated small data transmission in a wireless communication system. A User Equipment (UE) can apply Downlink (DL) Semi Persistent Scheduling (SPS) in a Mobile Terminated Small Data Transmission (MT-SDT) procedure. The UE can handle the configured DL assignment for DL SPS. A method for a UE in a wireless communication system can comprise receiving one or more configurations of DL SPS for Radio Resource Control Inactive (RRC_INACTIVE) state, initiating a MT-SDT procedure in response to receiving a paging indicating MT-SDT, receiving, in RRC_INACTIVE state, one or more DL transmissions using a configured DL assignment for the DL SPS during the MT-SDT procedure, and keeping the one or more configurations of the DL SPS and entering RRC_CONNECTED state in response to receiving a RRC resume message during the MT-SDT procedure.

### CROSS-REFERENCE TO RELATED APPLICATIONS

The present application claims priority to and the benefit of U.S. Provisional Patent Application Ser. No. 63/323,916, filed Mar. 25, 2022, which is fully incorporated herein by reference.

### FIELD

This disclosure generally relates to wireless communication networks and, more particularly, to a method and apparatus for mobile terminated small data transmission in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for mobile terminated small data transmission in a wireless communication system, wherein a User Equipment (UE) can apply Downlink (DL) Semi Persistent Scheduling (SPS) during/in a Mobile Terminated Small Data Transmission (MT-SDT) procedure. The UE can handle the configured DL assignment for DL SPS, e.g., when there is Uplink (UL) non-SDT data arrival.

In various embodiments, with this and other concepts, systems, and methods of the present invention, a method for a UE in a wireless communication system comprises receiving one or more configurations of DL SPS for Radio Resource Control Inactive (RRC_INACTIVE) state, initiating a MT-SDT procedure in response to receiving a paging indicating MT-SDT, receiving, in RRC_INACTIVE state, one or more DL transmissions using a configured DL assignment for the DL SPS during the MT-SDT procedure, and keeping the one or more configurations of the DL SPS and entering RRC_CONNECTED state in response to receiving a RRC resume message during the MT-SDT procedure.

In various embodiments, with this and other concepts, systems, and methods of the present invention, a method for a UE in a wireless communication system comprises receiving one or more configurations of DL SPS for RRC_INACTIVE state, initiating a MT-SDT procedure in response to receiving a paging indicating MT-SDT, receiving, in RRC_INACTIVE state, one or more DL transmissions using a configured DL assignment for the DL SPS during the MT-SDT procedure, and releasing the one or more configurations of the DL SPS, clearing the configured DL assignment, and entering RRC_CONNECTED state in response to receiving a RRC resume message during the MT-SDT procedure.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 7.3c-1: MT-EDT for Control Plane CIoT EPS Optimisation, from 3GPP TS 36.300 V16.7.0.

FIG. 6 is a reproduction of FIG. 7.3c-2: MT-EDT for User Plane CIoT EPS Optimisation, from 3GPP TS 36.300 V16.7.0.

FIG. 7 is a reproduction of FIG. 5.3.2.1-1: Paging, from 3GPP TS 38.331 V16.7.0.

FIG. 8 is a reproduction of FIG. 5.3.13.1-1: RRC connection resume, successful, from R2-2203768.

FIG. 9 is a reproduction of FIG. 5.3.13.1-2: RRC connection resume fallback to RRC connection establishment, successful, from R2-2203768.

FIG. 10 is a reproduction of FIG. 5.3.13.1-3: RRC connection resume followed by network release, successful, from R2-2203768.

FIG. 11 is a reproduction of FIG. 5.3.13.1-4: RRC connection resume followed by network suspend, successful, from R2-2203768.

FIG. 12 is a reproduction of FIG. 5.3.13.1-5: RRC connection resume, network reject, from R2-2203768.

FIG. 13 is a diagram showing the general concept of MO SDT, in accordance with embodiments of the present invention.

FIG. 14 is a diagram showing an example of non-SDT data arrival during MO-SDT, in accordance with embodiments of the present invention.

FIG. 15 is a diagram showing the general concept of MT-SDT, in accordance with embodiments of the present invention.

FIG. 16 is a diagram showing an example of MT-SDT with DL SPS, in accordance with embodiments of the present invention.

FIG. 17 is a flow diagram of a UE receiving a first paging from a NW indicating MT-SDT, in accordance with embodiments of the present invention.

FIG. 18 is a flow diagram of a UE receiving one or more configurations of DL SPS for a RRC_INACTIVE state, in accordance with embodiments of the present invention.

FIG. 19 is a flow diagram of a UE receiving one or more configurations of DL SPS for a RRC_INACTIVE state, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-193252, “New Work Item on NR small data transmissions in INACTIVE state”; [2] RP-212726, “WI on MT-SDT”; [3] 3GPP TS 36.300 V16.7.0, “E-UTRA, Overall description”; [4] 3GPP TS 38.321 V16.7.0, “NR, Medium Access Control (MAC) protocol specification”; [5] 3GPP TS 38.300 V16.8.0, “NR, NR and NG-RAN Overall description”; [6] 3GPP TS 38.331 V16.7.0, “NR, Radio Resource Control (RRC) protocol specification”; and [7] R2-2203768, “Introduction of SDT”. The standards and documents listed above are hereby expressly and fully incorporated herein by reference in their entirety.

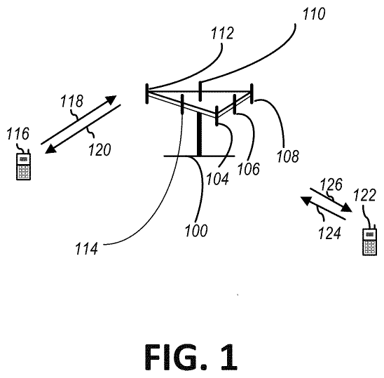

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

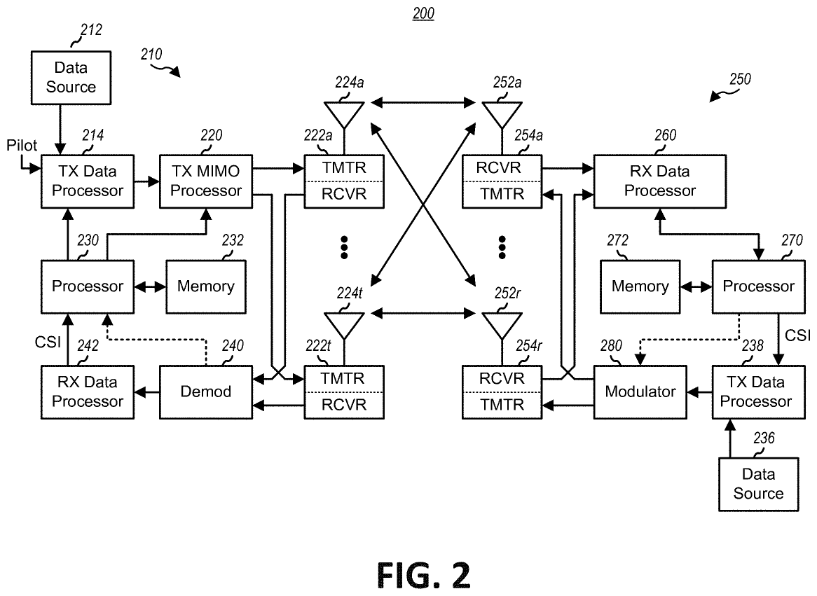

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, igitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

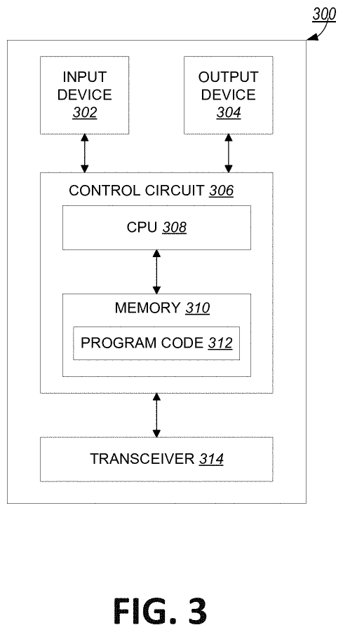

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

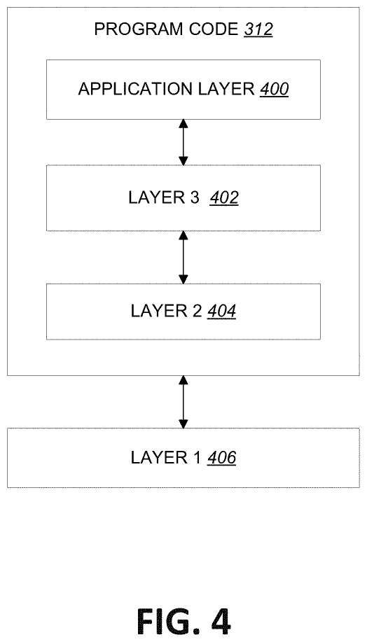

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The 3GPP release 17 work item of (mobile originated) small data transmission (SDT) is specified as below in [1] RP-193252, “New Work Item on NR small data transmissions in INACTIVE state”:

### Quotation Start [1]

### 3 Justification

NR supports RRC_INACTIVE state and UEs with infrequent (periodic and/or non-periodic) data transmission are generally maintained by the network in the RRC_INACTIVE state. Until Rel-16, the RRC_INACTIVE state doesn't support data transmission. Hence, the UE has to resume the connection (i.e. move to RRC_CONNECTED state) for any DL (MT) and UL (MO) data. Connection setup and subsequently release to INACTIVE state happens for each data transmission however small and infrequent the data packets are. This results in unnecessary power consumption and signalling overhead.

[ . . . ]

As noted in 3GPP TS 22.891, the NR system shall:
be efficient and flexible for low throughput short data bursts
support efficient signalling mechanisms (e.g. signalling is less than payload)
reduce signalling overhead in general

Signalling overhead from INACTIVE state UEs for small data packets is a general problem and will become a critical issue with more UEs in NR not only for network performance and efficiency but also for the UE battery performance. In general, any device that has intermittent small data packets in INACTIVE state will benefit from enabling small data transmission in INACTIVE.

The key enablers for small data transmission in NR, namely the INACTIVE state, 2-step, 4-step RACH and configured grant type-1 have already been specified as part of Rel-15 and Rel-16. So, this work builds on these building blocks to enable small data transmission in INACTIVE state for NR.

### 4 Objective

### 4.1 Objective of SI or Core Part WI or Testing Part WI

This work item enables small data transmission in RRC_INACTIVE state as follows:
For the RRC_INACTIVE state:
   UL small data transmissions for RACH-based schemes (i.e. 2-step and 4-step RACH):
      General procedure to enable UP data transmission for small data packets from INACTIVE state (e.g. using MSGA or MSG3) [RAN2]
      Enable flexible payload sizes larger than the Rel-16 CCCH message size that is possible currently for INACTIVE state for MSGA and MSG3 to support UP data transmission in UL (actual payload size can be up to network configuration) [RAN2]
      Context fetch and data forwarding (with and without anchor relocation) in INACTIVE state for RACH-based solutions [RAN2, RAN3]
      Note 1: The security aspects of the above solutions should be checked with SA3
   Transmission of UL data on pre-configured PUSCH resources (i.e. reusing the configured grant type 1)—when TA is valid
      General procedure for small data transmission over configured grant type 1 resources from INACTIVE state [RAN2]
      Configuration of the configured grant type1 resources for small data transmission in UL for INACTIVE state [RAN2]

### Quotation End

The work item for 3GPP release 18 has been discussed in RAN meetings, and the work item of mobile terminated (MT) SDT is specified as below in [2] RP-212726, “WI on MT-SDT”:

### Quotation Start [2]

### 3 Justification

Rel-17 specified MO-SDT to allow small packet transmission for UL-oriented packets. For DL, MT-SDT (i.e. DL-triggered small data) allows similar benefits, i.e. 1) reducing signalling overhead and UE power consumption by not transitioning to RRC_CONNECTED and reducing latency by allowing fast transmission of (small and infrequent) packets, e.g. for positioning.

### 4 Objective

### 4.1 Objective of SI or Core Part WI or Testing Part WI

Specify the support for paging-triggered SDT (MT-SDT) [RAN2, RAN3]
MT-SDT triggering mechanism for UEs in RRC_INACTIVE, supporting RA-SDT and CG-SDT as the UL response;
MT-SDT procedure for initial DL data reception and subsequent UL/DL data transmissions in RRC_INACTIVE.

### Quotation End

The stage 2 description of MT-EDT in LTE is specified in TS 36.300 ([3] 3GPP TS 36.300 V16.7.0, “E-UTRA, Overall description”) as below:

### Quotation Start [3]

### 7.3c MT-EDT

### 7.3c.1 General

MT-EDT is intended for a single downlink data transmission during the random access procedure.

MT-EDT is initiated by the MME if the UE and the network support MT-EDT and there is a single DL data transmission for the UE.

MT-EDT for Control Plane CIoT EPS Optimisation and for User Plane CIoT EPS Optimisation, as defined in TS 23.401 [17], is characterised as below:
Support for MT-EDT for the Control Plane CIoT EPS Optimisation and/or for the User Plane CIoT EPS Optimisation is reported by UE at NAS level;
DL data size is included in the S1-AP Paging message for the UE;
MT-EDT indication is included in the Paging message for the UE over the Uu interface;
For User Plane CIoT EPS Optimisation, the UE has been provided with a NextHopChainingCount in the RRCConnectionRelease message with suspend indication;
In response to the Paging message including MT-EDT indication, the UE triggers the MO-EDT procedure for Control Plane CIoT EPS Optimisation or for User Plane CIoT EPS Optimisation if the upper layers request the establishment or resumption of the RRC Connection for Mobile Terminated Call;
There is no transition to RRC CONNECTED.

MT-EDT is only applicable to BL UEs, UEs in enhanced coverage and NB-IoT UEs.

### 7.3c.2 MT-EDT for Control Plane CIoT EPS Optimisation

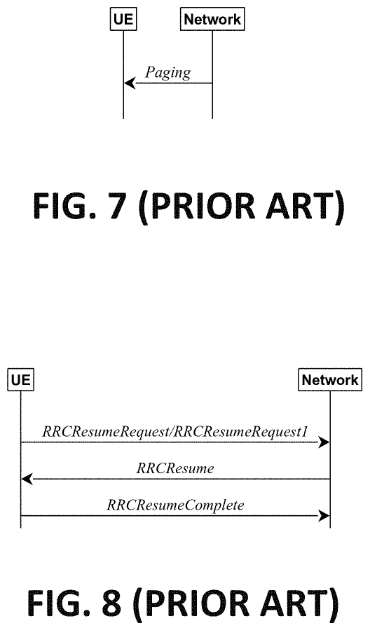

The MT-EDT procedure for Control Plane CIoT EPS Optimisation is illustrated in FIG. 7.3c-1.

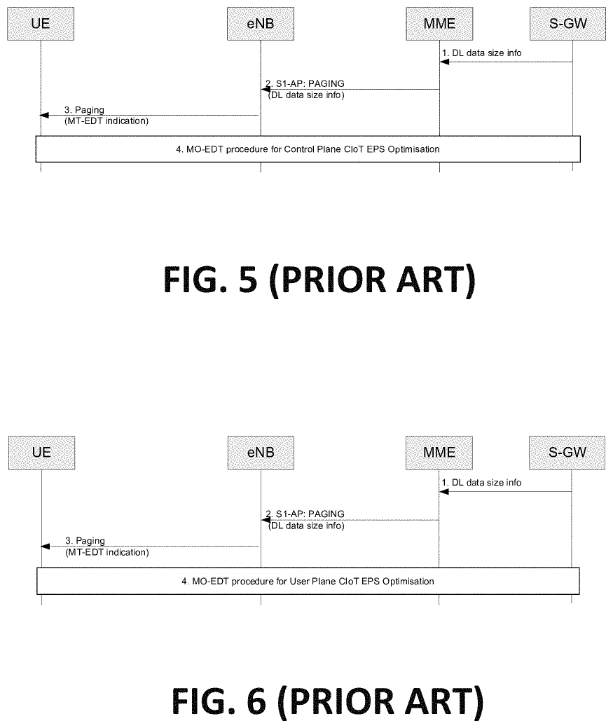

FIG. 5 is a reproduction of FIG. 7.3c-1: MT-EDT for Control Plane CIoT EPS Optimisation, from 3GPP TS 36.300 V16.7.0.
1. Upon arrival of downlink data, the SGW may send the DL data size information to the MME for MT-EDT consideration by the MME.
2. The MME includes the DL data size information in the S1-AP PAGING message to assist eNodeB in triggering MT-EDT.
3. If the data can fit in one single downlink transmission according to the UE category included in the UE Radio Capability for Paging provided in the S1-AP Paging message, the eNB includes mt-EDT indication in the Paging message for the UE.
4. The UE initiates the MO-EDT procedure for the Control Plane CIoT EPS Optimisation as described in clause 7.3b.2 with the following differences:
   In step 1, the UE sends RRCEarlyDataRequest message with the establishment cause mt-Access and without user data.
   In step 7, in case of fallback to the RRC Connection establishment procedure, the downlink data may optionally be included in RRCConnectionSetup message.

### 7.3c.3 MT-EDT for User Plane CIoT EPS Optimisation

The MT-EDT procedure for User Plane CIoT EPS Optimisation is illustrated in FIG. 7.3c-2.

FIG. 6 is a reproduction of FIG. 7.3c-2: MT-EDT for User Plane CIoT EPS Optimisation, from 3GPP TS 36.300 V16.7.0.
1. Upon arrival of downlink data, the SGW may send the DL data size to the MME for MT-EDT consideration by the MME.
30 2. The MME includes the DL data size in the S1-AP PAGING message to assist eNodeB in triggering MT-EDT.
3. If the data can fit in one single downlink transmission according to the UE category included in the UE Radio Capability for Paging provided in the S1-AP Paging message, the eNB includes mt-EDT indication in the Paging message for the UE.
4. The UE initiates the MO-EDT procedure for the User Plane CIoT EPS Optimisation as described in clause 7.3b.3/FIG. 7.3b-2 with the following differences:
   In step 0, the UE selects a random access preamble not configured for EDT;
   In step 1, the UE sends RRCConnectionResumeRequest message with the resume cause mt-EDT and without user data.
   In step 4, the MME may include the Pending Data Indication in the SLAP UE Context Resume Response message to notify the eNB of further data traffic in excess of that initially signalled in step 2. The eNB may use this indication to decide whether to release the UE.

### Quotation End

The procedure related to DL transmission and semi-persistent scheduling (SPS) in NR are specified in TS 38.321 ([4] 3GPP TS 38.321 V16.7.0, “NR, Medium Access Control (MAC) protocol specification”) and TS 38.300 ([5] 3GPP TS 38.300 V16.8.0, “NR, NR and NG-RAN Overall description”) as below:

### Quotation Start [4]

### 5.3 DL-SCH Data Transfer

### 5.3.1 DL Assignment Reception

Downlink assignments received on the PDCCH both indicate that there is a transmission on a DL-SCH for a particular MAC entity and provide the relevant HARQ information.

When the MAC entity has a C-RNTI, Temporary C-RNTI, or CS-RNTI, the MAC entity shall for each PDCCH occasion during which it monitors PDCCH and for each Serving Cell:
1> if a downlink assignment for this PDCCH occasion and this Serving Cell has been received on the PDCCH for the MAC entity's C-RNTI, or Temporary C-RNTI:
   2> if this is the first downlink assignment for this Temporary C-RNTI:
      3> consider the NDI to have been toggled.
   2> if the downlink assignment is for the MAC entity's C-RNTI, and if the previous downlink assignment indicated to the HARQ entity of the same HARQ process was either a downlink assignment received for the MAC entity's CS-RNTI or a configured downlink assignment:
      3> consider the NDI to have been toggled regardless of the value of the NDI.
   2> indicate the presence of a downlink assignment and deliver the associated HARQ information to the HARQ entity.
1> else if a downlink assignment for this PDCCH occasion has been received for this Serving Cell on the PDCCH for the MAC entity's CS-RNTI:
   2> if the NDI in the received HARQ information is 1:
      3> consider the NDI for the corresponding HARQ process not to have been toggled;
      3> indicate the presence of a downlink assignment for this Serving Cell and deliver the associated HARQ information to the HARQ entity.
   2> if the NDI in the received HARQ information is 0:
      3> if PDCCH contents indicate SPS deactivation:
         4> clear the configured downlink assignment for this Serving Cell (if any);
         4> if the timeAlignmentTimer, associated with the TAG containing the Serving Cell on which the HARQ feedback is to be transmitted, is running:
         5> indicate a positive acknowledgement for the SPS deactivation to the physical layer.
      3> else if PDCCH content indicates SPS activation:
         4> store the downlink assignment for this Serving Cell and the associated HARQ information as configured downlink assignment;
         4> initialise or re-initialise the configured downlink assignment for this Serving Cell to start in the associated PDSCH duration and to recur according to rules in clause 5.8.1;

For each Serving Cell and each configured downlink assignment, if configured and activated, the MAC entity shall:
1> if the PDSCH duration of the configured downlink assignment does not overlap with the PDSCH duration of a downlink assignment received on the PDCCH for this Serving Cell:
   2> instruct the physical layer to receive, in this PDSCH duration, transport block on the DL-SCH according to the configured downlink assignment and to deliver it to the HARQ entity;
   2> set the HARQ Process ID to the HARQ Process ID associated with this PDSCH duration;
   2> consider the NDI bit for the corresponding HARQ process to have been toggled;
   2> indicate the presence of a configured downlink assignment and deliver the stored HARQ information to the HARQ entity.
      [ . . . ]

### 5.3.2 HARQ Operation

### 5.3.2.1 HARQ Entity

The MAC entity includes a HARQ entity for each Serving Cell, which maintains a number of parallel HARQ processes. Each HARQ process is associated with a HARQ process identifier. The HARQ entity directs HARQ information and associated TBs received on the DL-SCH to the corresponding HARQ processes (see clause 5.3.2.2).

The number of parallel DL HARQ processes per HARQ entity is specified in TS 38.214 [7]. The dedicated broadcast HARQ process is used for BCCH.

The HARQ process supports one TB when the physical layer is not configured for downlink spatial multiplexing. The HARQ process supports one or two TBs when the physical layer is configured for downlink spatial multiplexing.

When the MAC entity is configured with pdsch-AggregationFactor>1, the parameter pdsch-AggregationFactor provides the number of transmissions of a TB within a bundle of the downlink assignment. Bundling operation relies on the HARQ entity for invoking the same HARQ process for each transmission that is part of the same bundle. After the initial transmission, pdsch-AggregationFactor−1 HARQ retransmissions follow within a bundle.

The MAC entity shall:
1> if a downlink assignment has been indicated:
   2> allocate the TB(s) received from the physical layer and the associated HARQ information to the HARQ process indicated by the associated HARQ information.
1> if a downlink assignment has been indicated for the broadcast HARQ process:
   2> allocate the received TB to the broadcast HARQ process.

### 5.3.2.2 HARQ Process

When a transmission takes place for the HARQ process, one or two (in case of downlink spatial multiplexing) TBs and the associated HARQ information are received from the HARQ entity.

For each received TB and associated HARQ information, the HARQ process shall:
1> if the NDI, when provided, has been toggled compared to the value of the previous received transmission corresponding to this TB; or
1> if the HARQ process is equal to the broadcast process, and this is the first received transmission for the TB according to the system information schedule indicated by RRC; or
1> if this is the very first received transmission for this TB (i.e. there is no previous NDI for this TB):
   2> consider this transmission to be a new transmission.
1> else:
   2> consider this transmission to be a retransmission.

The MAC entity then shall:
1> if this is a new transmission:
   2> attempt to decode the received data.
1> else if this is a retransmission:
   2> if the data for this TB has not yet been successfully decoded:
      3> instruct the physical layer to combine the received data with the data currently in the soft buffer for this TB and attempt to decode the combined data.
1> if the data which the MAC entity attempted to decode was successfully decoded for this TB; or
1> if the data for this TB was successfully decoded before:
   2> if the HARQ process is equal to the broadcast process:
      3> deliver the decoded MAC PDU to upper layers.
   2> else if this is the first successful decoding of the data for this TB:
      3> deliver the decoded MAC PDU to the disassembly and demultiplexing entity.
1> else:
   2> instruct the physical layer to replace the data in the soft buffer for this TB with the data which the MAC entity attempted to decode.
1> if the HARQ process is associated with a transmission indicated with a Temporary C-RNTI and the Contention Resolution is not yet successful (see clause 5.1.5); or
1> if the HARQ process is associated with a transmission indicated with a MSGB-RNTI and the Random Access procedure is not yet successfully completed (see clause 5.1.4a); or
1> if the HARQ process is equal to the broadcast process; or
1> if the timeAlignmentTimer, associated with the TAG containing the Serving Cell on which the HARQ feedback is to be transmitted, is stopped or expired:
   2> not instruct the physical layer to generate acknowledgement(s) of the data in this TB.
1> else:
   2> instruct the physical layer to generate acknowledgement(s) of the data in this TB.

### Next Quotation

### 5.8 Transmission and Reception without Dynamic Scheduling

### 5.8.1 Downlink

Semi-Persistent Scheduling (SPS) is configured by RRC for a Serving Cell per BWP. Multiple assignments can be active simultaneously in the same BWP. Activation and deactivation of the DL SPS are independent among the Serving Cells.

For the DL SPS, a DL assignment is provided by PDCCH, and stored or cleared based on L1 signalling indicating SPS activation or deactivation.

RRC configures the following parameters when the SPS is configured:
cs-RNTI: CS-RNTI for activation, deactivation, and retransmission;
nrofHARQ-Processes: the number of configured HARQ processes for SPS;
harq-ProcID-Offset: Offset of HARQ process for SPS;
periodicity: periodicity of configured downlink assignment for SPS.

When the SPS is released by upper layers, all the corresponding configurations shall be released.

After a downlink assignment is configured for SPS, the MAC entity shall consider sequentially that the N^{th} downlink assignment occurs in the slot for which:

(numberOfSlotsPerFrame×SFN+slot number in the frame)=[(numberOfSlotsPerFrame×SFN_{start time}±slot_{start time})+N×periodicity×numberOfSlotsPerFrame/10]modulo(1024×numberOfSlotsPerFrame)

where SFN_{start time} and slot_{start time} are the SFN and slot, respectively, of the first transmission of PDSCH where the configured downlink assignment was (re-)initialised.
NOTE: In case of unaligned SFN across carriers in a cell group, the SFN of the concerned Serving Cell is used to calculate the occurrences of configured downlink assignments.

### Quotation End

### Quotation Start [5]

### 10.2 Downlink Scheduling

In the downlink, the gNB can dynamically allocate resources to UEs via the C-RNTI on PDCCH(s). A UE always monitors the PDCCH(s) in order to find possible assignments when its downlink reception is enabled (activity governed by DRX when configured). When CA is configured, the same C-RNTI applies to all serving cells.

The gNB may pre-empt an ongoing PDSCH transmission to one UE with a latency-critical transmission to another UE. The gNB can configure UEs to monitor interrupted transmission indications using INT-RNTI on a PDCCH. If a UE receives the interrupted transmission indication, the UE may assume that no useful information to that UE was carried by the resource elements included in the indication, even if some of those resource elements were already scheduled to this UE.

In addition, with Semi-Persistent Scheduling (SPS), the gNB can allocate downlink resources for the initial HARQ transmissions to UEs: RRC defines the periodicity of the configured downlink assignments while PDCCH addressed to CS-RNTI can either signal and activate the configured downlink assignment, or deactivate it; i.e. a PDCCH addressed to CS-RNTI indicates that the downlink assignment can be implicitly reused according to the periodicity defined by RRC, until deactivated.
NOTE: When required, retransmissions are explicitly scheduled on PDCCH(s).

The dynamically allocated downlink reception overrides the configured downlink assignment in the same serving cell, if they overlap in time. Otherwise a downlink reception according to the configured downlink assignment is assumed, if activated.

The UE may be configured with up to 8 active configured downlink assignments for a given BWP of a serving cell. When more than one is configured:
The network decides which of these configured downlink assignments are active at a time (including all of them); and
Each configured downlink assignment is activated separately using a DCI command and deactivation of configured downlink assignments is done using a DCI command, which can either deactivate a single configured downlink assignment or multiple configured downlink assignments jointly.

### Quotation End

The paging procedure in NR is specified in TS 38.331 ([6] 3GPP TS 38.331 V16.7.0, “NR, Radio Resource Control (RRC) protocol specification”) as below:

### Quotation Start [6]

### 5.3.2 Paging

### 5.3.2.1 General

FIG. 7 is a reproduction of FIG. 5.3.2.1-1: Paging, from 3GPP TS 38.331 V16.7.0.

The purpose of this procedure is:
to transmit paging information to a UE in RRC_IDLE or RRC_INACTIVE.

### 5.3.2.2 Initiation

The network initiates the paging procedure by transmitting the Paging message at the UE's paging occasion as specified in TS 38.304 [20]. The network may address multiple UEs within a Paging message by including one PagingRecord for each UE.

### 5.3.2.3 Reception of the Paging Message by the UE

Upon receiving the Paging message, the UE shall:
1> if in RRC_IDLE, for each of the PagingRecord, if any, included in the Paging message:
   2> if the ue-Identity included in the PagingRecord matches the UE identity allocated by upper layers:
      3> forward the ue-Identity and accessType (if present) to the upper layers;
1> if in RRC_INACTIVE, for each of the PagingRecord, if any, included in the Paging message:
   2> if the ue-Identity included in the PagingRecord matches the UE's stored fulll-RNTI:
      3> if the UE is configured by upper layers with Access Identity 1:
         4> initiate the RRC connection resumption procedure according to 5.3.13 with resume Cause set to mps-PriorityAccess;
      3> else if the UE is configured by upper layers with Access Identity 2:
         4> initiate the RRC connection resumption procedure according to 5.3.13 with resume Cause set to mcs-PriorityAccess;
      3> else if the UE is configured by upper layers with one or more Access Identities equal to 11-15:
         4> initiate the RRC connection resumption procedure according to 5.3.13 with resume Cause set to highPriorityAccess;
      3> else:
         4> initiate the RRC connection resumption procedure according to 5.3.13 with resume Cause set to mt-Access;
   2> else if the ue-Identity included in the PagingRecord matches the UE identity allocated by upper layers:
      3> forward the ue-Identity to upper layers and accessType (if present) to the upper layers;
      3> perform the actions upon going to RRC_IDLE as specified in 5.3.11 with release cause ‘other’.

### Quotation End

The RRC Resume procedure in NR is specified in [6] 3GPP TS 38.331 V16.7.0, “NR, Radio Resource Control (RRC) protocol specification”, and the related procedure in running CR for (MO-)SDT is specified as below in [7] R2-2203768, “Introduction of SDT”:

### Quotation Start [7]

### 5.3.13 RRC Connection Resume

### 5.3.13.1 General

FIG. 8 is a reproduction of FIG. 5.3.13.1-1: RRC connection resume, successful, from R2-2203768.

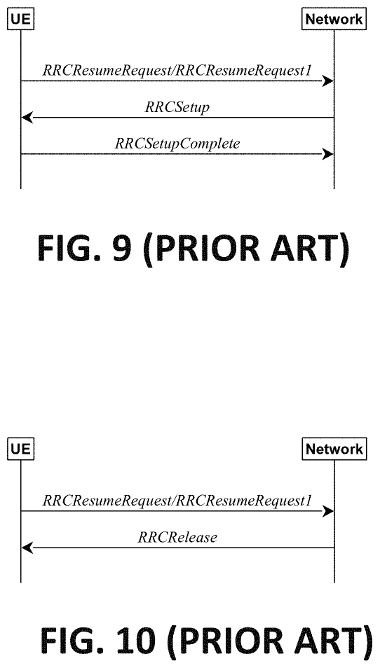

FIG. 9 is a reproduction of FIG. 5.3.13.1-2: RRC connection resume fallback to RRC connection establishment, successful, from R2-2203768

FIG. 10 is a reproduction of FIG. 5.3.13.1-3: RRC connection resume followed by network release, successful, from R2-2203768.

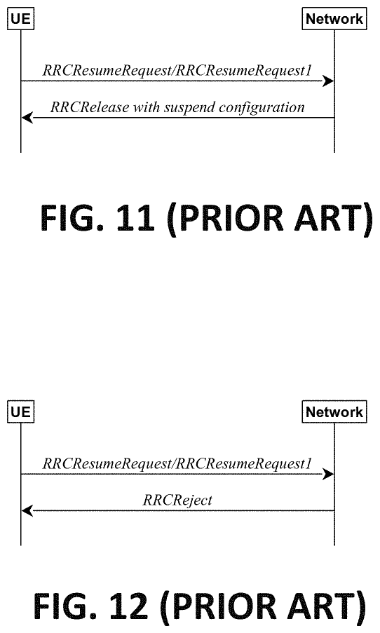

FIG. 11 is a reproduction of FIG. 5.3.13.1-4: RRC connection resume followed by network suspend, successful, from R2-2203768.

FIG. 12 is a reproduction of FIG. 5.3.13.1-5: RRC connection resume, network reject, from R2-2203768.

The purpose of this procedure is to resume a suspended RRC connection, including resuming SRB(s) and DRB(s) or perform an RNA update. This procedure is also used to initiate SDT in RRC_INACTIVE.

[ . . . ]

### 5.3.13.1b Conditions for Initiating SDT

A UE in RRC_INACTIVE initiates the resume procedure for SDT when all of the following conditions are fulfilled:
1> the upper layers request resumption of RRC connection; and
1> SIB1 includes sdt-ConfigCommon; and
1> sdt-Config is configured; and 1> all the pending data in UL is mapped to the radio bearers configured for SDT; and
1> lower layers indicate that conditions for initiating SDT as specified in TS 38.321 [3] are fulfilled.

### 5.3.13.2 Initiation

The UE initiates the procedure when upper layers or AS (when responding to RAN paging, upon triggering RNA updates while the UE is in RRC_INACTIVE, for NR sidelink communication/V2X sidelink communication as specified in sub-clause 5.3.13.1a) requests the resume of a suspended RRC connection or for initiating SDT as specified in sub-clause 5.3.13.1b.

The UE shall ensure having valid and up to date essential system information as specified in clause 5.2.2.2 before initiating this procedure.

Upon initiation of the procedure, the UE shall:
1> if the resumption of the RRC connection is triggered by response to NG-RAN paging:
   2> select ‘0’ as the Access Category;
   2> perform the unified access control procedure as specified in 5.3.14 using the selected Access Category and one or more Access Identities provided by upper layers;
      3> if the access attempt is barred, the procedure ends;
1> else if the resumption of the RRC connection is triggered by upper layers:
   2> if the upper layers provide an Access Category and one or more Access Identities:
      3> perform the unified access control procedure as specified in 5.3.14 using the Access Category and Access Identities provided by upper layers;
         4> if the access attempt is barred, the procedure ends;
   2> if the resumption occurs after release with redirect with mpsPriorityIndication:
      3> set the resumeCause to mps-PriorityAccess;
   2> else:
      3> set the resumeCause in accordance with the information received from upper layers;
         [ . . . ]
1> apply the default L1 parameter values as specified in corresponding physical layer specifications, except for the parameters for which values are provided in SIB1;
1> apply the default SRB1 configuration as specified in 9.2.1;
1> apply the default MAC Cell Group configuration as specified in 9.2.2;
1> release delayBudgetReportingConfig from the UE Inactive AS context, if stored;
1> stop timer T342, if running;
1> release overheatingAssistanceConfig from the UE Inactive AS context, if stored;
1> stop timer T345, if running;
1> release idc-AssistanceConfig from the UE Inactive AS context, if stored;
1> release drx-PreferenceConfig for all configured cell groups from the UE Inactive AS context, if stored;
1> stop all instances of timer T346a, if running;
1> release maxBW-PreferenceConfig for all configured cell groups from the UE Inactive AS context, if stored;
1> stop all instances of timer T346b, if running;
1> release maxCC-PreferenceConfig for all configured cell groups from the UE Inactive AS context, if stored;
1> stop all instances of timer T346c, if running;
1> release maxMIMO-LayerPreferenceConfig for all configured cell groups from the UE Inactive AS context, if stored;
1> stop all instances of timer T346d, if running;
1> release minSchedulingOffsetPreferenceConfig for all configured cell groups from the UE Inactive AS context, if stored;
1> stop all instances of timer T346e, if running;
1> release releasePreferenceConfig from the UE Inactive AS context, if stored;
1> release wlanNameList from the UE Inactive AS context, if stored;
1> release btNameList from the UE Inactive AS context, if stored;
1> release sensorNameList from the UE Inactive AS context, if stored;
1> release obtainCommonLocation from the UE Inactive AS context, if stored;
1> stop timer T346f, if running;
1> release referenceTimePreferenceReporting from the UE Inactive AS context, if stored;
1> release sl-AssistanceConfigNR from the UE Inactive AS context, if stored;
1> apply the CCCH configuration as specified in 9.1.1.2;
1> apply the timeAlignmentTimerCommon included in SIB1;
1> if sdt-MAC-PHY-CG-Config is configured:
   2> if the resume procedure is initiated in a cell that is different to the PCell in which the UE received the stored sdt-MAC-PHY-CG-Config:
      3> release the stored sdt-MAC-PHY-CG-Config;
1> if conditions for initiating SDT in accordance with 5.3.13.1b are fulfilled:
   2> consider the resume procedure is initiated for SDT;
   2> start timer T319a;
1> else:
   2> start timer T319;
   2> instruct the MAC entity to consider the cg-SDT-TimeAlignmentTimer as expired, if it is running;
1> set the variable pendingRNA-Update to false;
1> initiate transmission of the RRCResumeRequest message or RRCResumeRequest1 in accordance with 5.3.13.3.

### 5.3.13.3 Actions Related to Transmission of RRCResumeRequest or RRCResumeRequest1 Message

The UE shall set the contents of RRCResumeRequest or RRCResumeRequest1 message as follows:
1> if field useFullResumeID is signalled in SIB1:
   2> select RRCResumeRequest1 as the message to use;
   2> set the resumeIdentity to the stored fulll-RNTI value;
1> else:
   2> select RRCResumeRequest as the message to use;
   2> set the resumeIdentity to the stored shortl-RNTI value;
1> restore the RRC configuration, RoHC state, the stored QoS flow to DRB mapping rules and the K_{gNB} and K_{RRCint} keys from the stored UE Inactive AS context except for the following:
   masterCellGroup;
   mrdc-SecondaryCellGroup, if stored; and
   pdcp-Config;
1> set the resumeMAC-I to the 16 least significant bits of the MAC-I calculated:
   2> over the ASN.1 encoded as per clause 8 (i.e., a multiple of 8 bits) VarResumeMAC-Input;
   2> with the K_{RRCint} key in the UE Inactive AS Context and the previously configured integrity protection algorithm; and
   2> with all input bits for COUNT, BEARER and DIRECTION set to binary ones;
1> derive the K_{gNB} key based on the current K_{gNB} key or the NH, using the stored nextHopChainingCount value, as specified in TS 33.501 [11];
1> derive the K_{RRCenc} key, K_{RRCinc} key, the K_{UPint} key, the K_{UPenc} key;
1> configure lower layers to apply integrity protection for all radio bearers except SRB0 using the configured algorithm and the K_{RRCint} key and K_{UPint} key derived in this subclause immediately, i.e., integrity protection shall be applied to all subsequent messages received and sent by the UE;
NOTE 1: Only DRBs with previously configured UP integrity protection shall resume integrity protection.
1> configure lower layers to apply ciphering for all radio bearers except SRB0 and to apply the configured ciphering algorithm, the K_{RRCenc} key and K_{UPenc} key derived in this subclause, i.e. the ciphering configuration shall be applied to all subsequent messages received and sent by the UE;
1> re-establish PDCP entities for SRB1;
1> resume SRB1;
1> if the resume procedure is initiated for SDT:
   2> for each radio bearer that is configured for SDT:
      3> restore the configuration associated with the RLC bearers of masterCellGroup and pdcp-Config from the UE Inactive AS context;
      3> re-establish PDCP entity for the radio bearer without triggering PDCP status report;
   2> resume all the radio bearers that are configured for SDT;
1> submit the selected message RRCResumeRequest or RRCResumeRequest1 for transmission to lower layers.
NOTE 2: Only DRBs with previously configured UP ciphering shall resume ciphering.

If lower layers indicate an integrity check failure while T319 or T319a is running, perform actions specified in 5.3.13.5.

The UE shall continue cell re-selection related measurements as well as cell re-selection evaluation. If the conditions for cell re-selection are fulfilled, the UE shall perform cell re-selection as specified in 5.3.13.6.

### 5.3.13.4 Reception of the RRCResume by the UE

The UE shall:
1> stop timer T319, if running;
1> stop timer T319a, if running;
   [ . . . ]
1> if the RRCResume includes the fullConfig:
   2> perform the full configuration procedure as specified in 5.3.5.11;
1> else:
   2> if the RRCResume does not include the restoreMCG-SCells:
      3> release the MCG SCell(s) from the UE Inactive AS context, if stored;
   2> if the RRCResume does not include the restoreSCG:
      3> release the MR-DC related configurations (i.e., as specified in 5.3.5.10) from the UE Inactive AS context, if stored;
   2> restore the masterCellGroup, mrdc-SecondaryCellGroup, if stored, and pdcp-Config from the UE Inactive AS context;
   2> configure lower layers to consider the restored MCG and SCG SCell(s) (if any) to be in deactivated state;
1> discard the UE Inactive AS context;
1> release the suspendConfig except the ran-NotificationAreaInfo;
1> if the RRCResume includes the masterCellGroup:
   2> perform the cell group configuration for the received masterCellGroup according to 5.3.5.5;
1> if the RRCResume includes the mrdc-SecondaryCellGroup:
   2> if the received mrdc-SecondaryCellGroup is set to nr-SCG:
      3> perform the RRC reconfiguration according to 5.3.5.3 for the RRCReconfiguration message included in nr-SCG;
   2> if the received mrdc-SecondaryCellGroup is set to eutra-SCG:
      3> perform the RRC connection reconfiguration as specified in TS 36.331 [10], clause 5.3.5.3 for the RRCConnectionReconfiguration message included in eutra-SCG;
1> if the RRCResume includes the radioBearerConfig:
   2> perform the radio bearer configuration according to 5.3.5.6;
1> if the RRCResume message includes the sk-Counter:
   2> perform security key update procedure as specified in 5.3.5.7;
1> if the RRCResume message includes the radioBearerConfig2:
   2> perform the radio bearer configuration according to 5.3.5.6;
1> if the RRCResume message includes the needForGapsConfigNR:
   2> if needForGapsConfigNR is set to setup:
      3> consider itself to be configured to provide the measurement gap requirement information of NR target bands;
   2> else:
      3> consider itself not to be configured to provide the measurement gap requirement information of NR target bands;
1> resume SRB2 (if suspended), SRB3 (if configured), and all DRBs (that are suspended);
1> if stored, discard the cell reselection priority information provided by the cellReselectionPriorities or inherited from another RAT;
1> stop timer T320, if running;
1> if the RRCResume message includes the measConfig:
   2> perform the measurement configuration procedure as specified in 5.5.2;
1> resume measurements if suspended;
1> if T390 is running:
   2> stop timer T390 for all access categories;
   2> perform the actions as specified in 5.3.14.4;
1> if T302 is running:
   2> stop timer T302;
   2> perform the actions as specified in 5.3.14.4;
1> enter RRC_CONNECTED;
1> indicate to upper layers that the suspended RRC connection has been resumed;
1> stop the cell re-selection procedure;
1> consider the current cell to be the PCell;
1> set the content of the of RRCResumeComplete message as follows:
   [ . . . ]
1> submit the RRCResumeComplete message to lower layers for transmission;
1> the procedure ends.

### 5.3.13.5 Handling of Failure to Resume RRC Connection

The UE shall:
1> if timer T319 expires:
   2> if the UE has connection establishment failure information or connection resume failure information available in VarConnEstFailReport and if the RPLMN is not equal to plmn-identity stored in VarConnEstFailReport; or
   2> if the cell identity of current cell is not equal to the cell identity stored in measResultFailedCell in VarConnEstFailReport:
      3> reset the numberOfConnFail to 0;
   2> clear the content included in VarConnEstFailReport except for the numberOfConnFail, if any;
   2> store the following connection resume failure information in the VarConnEstFailReport by setting its fields as follows:
      3> set the plmn-Identity to the PLMN selected by upper layers (see TS 24.501 [23]) from the PLMN(s) included in the plmn-IdentityInfoList in SIB1;
      3> set the measResultFailedCell to include the global cell identity, tracking area code, the cell level and SS/PBCH block level RSRP, and RSRQ, and SS/PBCH block indexes, of the failed cell based on the available SSB measurements collected up to the moment the UE detected connection resume failure;
      3> if available, set the measResultNeighCells, in order of decreasing ranking-criterion as used for cell re-selection, to include neighbouring cell measurements for at most the following number of neighbouring cells: 6 intra-frequency and 3 inter-frequency neighbours per frequency as well as 3 inter-RAT neighbours, per frequency/set of frequencies per RAT and according to the following:
         4> for each neighbour cell included, include the optional fields that are available;
NOTE: The UE includes the latest results of the available measurements as used for cell reselection evaluation, which are performed in accordance with the performance requirements as specified in TS 38.133 [14].
   3> if available, set the locationInfo as in 5.3.3.7;
   3> set perRAInfoList to indicate the performed random access procedure related information as specified in 5.7.10.5;
   3> if numberOfConnFail is smaller than 8:
      4> increment the numberOfConnFail by 1;
   2> perform the actions upon going to RRC_IDLE as specified in 5.3.11 with release cause ‘RRC Resume failure’.
1> else if upon receiving Integrity check failure indication from lower layers while T319 or T319a is running:
   2> perform the actions upon going to RRC_IDLE as specified in 5.3.11 with release cause ‘RRC Resume failure’.
1> else if indication from the MCG RLC that the maximum number of retransmissions has been reached is received while T319a is running; or
1> if random access problem indication is received from MCG MAC while T319a is running; or
1> if the lower layers indicate that cg-SDT-TimeAlignmentTimer expired before receiving network response for the UL CG-SDT transmission with CCCH message while T319a is running; or
1> if T319a expires:
   2> perform the actions upon going to RRC_IDLE as specified in 5.3.11 with release cause ‘RRC Resume failure’.

### Quotation End

In New Radio (NR), small data transmission (SDT) is introduced to transmit and/or receive user data (e.g., small data) in RRC_INACTIVE state without establishing (or resuming) a Radio Resource Control (RRC) connection, and subsequently in release [1] RP-193252, “New Work Item on NR small data transmissions in INACTIVE state”, which could save power consumption and signalling overhead. In current 3GPP meetings, the mobile originated (MO) SDT has been discussed in NR release 17. For (MO)-SDT, in response to Uplink (UL) data (e.g., small data) available for transmission while the User Equipment (UE) is in RRC_INACTIVE state, the UE may initiate a RRC connection resume procedure which triggers a Random Access (RA) procedure (e.g., RA-SDT) and/or transmissions on pre-configured Physical Uplink Shared Channel (PUSCH) resources (e.g., Configured Grant-based SDT (CG-SDT)). The UE would be configured with the CG-SDT resources (e.g., CG Type 1 resources) in a RRC Release message (e.g., RRCRelease) from a Network (NW) in RRC_CONNECTED state. The UE may send a RRC request message (e.g., RRCResumeRequest) and the small data in a Msg3 (in RA-SDT), Message A (MSGA) (in RA-SDT), and/or Protocol Data Unit (PDU) to be transmitted using the CG-SDT resources (in CG-SDT). If there is more data which could not be transmitted within the first (or initial) small data transmission (e.g., in Msg3, MSGA, and/or the first PDU using CG-SDT resources), subsequent small data transmission(s) and the RRC state transition decision would be under NW control. The subsequent small data may be transmitted using (pre-) configured PUSCH resources (of CG-SDT), and/or dynamic grant(s) provided by the NW. There may be one or more subsequent small data transmissions after the first (or initial) small data transmission. If there is no more subsequent small data in the UE (e.g., indicates by a Buffer Status Report (BSR)) and/or if the NW decides to complete the (MO-)SDT procedure, the NW may send a RRC release message (e.g., RRCRelease) (e.g., with suspendConfig) to the UE. If the NW decides to transition the UE to RRC_CONNECTED state (and transmit Uplink/Downlink (UL/DL) data in RRC_CONNECTED state), the NW may send a RRC resume message (e.g., RRCResume) to the UE.

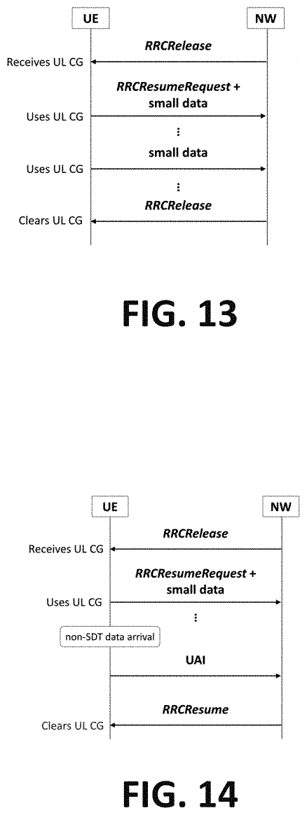

For example, as shown in FIG. 13, the NW could configure and/or provide Type 1 configured (UL) grant in a first RRC Release message (e.g., RRCRelease). In response to receiving the first RRC Release message (e.g., RRCRelease), the UE may transition to RRC_INACTIVE state. The UE may initiate a SDT procedure and use the configured UL grant to transmit multiple small data (e.g., first/initial small data transmission and subsequent small data transmission) in RRC_INACTIVE state. When receiving a second RRC Release message (e.g., RRCRelease) in the end of the SDT procedure, the UE may reset Medium Access Control (MAC) and clear the configured UL grant.

For example, as shown in FIG. 14, the NW could resume the UE into RRC_CONNECTED to transmit non-SDT. When non-SDT data arrives during a SDT procedure, the UE may inform the NW by a UE assistance information (UAI). The NW may transmit the RRC resume message (e.g., RRCResume) to the UE. In response to receiving the RRC resume message (e.g., RRCResume), the UE may enter RRC_CONNECTED state and clear the configured UL grant by considering a Timing Advance (TA) timer for CG-SDT (e.g., cg-SDT-TimeAlignmentTimer) as expired. In response to receiving the RRC resume message (e.g., RRCResume), the UE may terminate the SDT procedure.

On the other hand, the UE could perform MO-EDT and/or MT-EDT (mobile terminated EDT) in RRC_IDLE state in LTE. The UE could initiate a MO-EDT procedure for one UL data transmission. The NW could indicate the UE to initiate a MT-EDT procedure for a single DL data transmission ([3] 3GPP TS 36.300 V16.7.0, “E-UTRA, Overall description”). When the NW has DL data to transmit, the NW could send a paging including MT-EDT indication (e.g., mt-EDT set to TRUE) to the UE. In response to the paging, the UE may select a RA preamble not configured for EDT and trigger a RA procedure. The RA procedure is a normal RA procedure (e.g., a RA procedure without UL data in Msg3, a RA procedure using RA resources not for EDT). The UE may send a RRC Resume request message (e.g., RRCConnectionResumeRequest) with the resume cause as mt-EDT in a Msg3 in the RA procedure. Then the NW may send a RRC Release message (e.g., RRCRelease) and the DL data in a Msg4 to complete the RA and MT-EDT procedure.

Further enhancements and/or additional features may be introduced for SDT in NR release 18, e.g., for latency reduction and power saving ([2] RP-212726, “WI on MT-SDT”). For example, the mobile terminated MT-SDT would be introduced to support the case of DL data arrival in RRC_INACTIVE state. The UE may receive a paging to trigger a MT-SDT procedure, and respond to the NW by RA-SDT and/or CG-SDT. For example, the UE may receive a paging including a MT-SDT indication. In response to receiving the paging, the UE may initiate a 2-step RA-SDT, 4-step RA-SDT, and/or CG-SDT. The UE may transmit an initial/first UL (data) transmission as an UL response. The UE may transmit the UL response (and/or initial/first UL (data) transmission) in a MSGA, Msg3 and/or PDU to be transmitted using CG-SDT resources. The UL response may be a RRC message (e.g., RRCResumeRequest). The UE may receive a (initial/first) DL (data) transmission after transmitting the UL response. The UE may receive one or more (subsequent) DL (data) transmission(s) after receiving the (initial/first) DL (data) transmission. The UE may transmit one or more (subsequent) UL (data) transmission(s) after receiving the (initial/first) DL (data) transmission.

There may be difference between MT-SDT in NR and MT-EDT in LTE. The UE receives DL data in a RA procedure for MT-EDT in LTE, while the UE may receive DL data in a RA procedure (e.g., RA-SDT) and/or via CG resources (e.g., CG-SDT) in NR. There is one DL transmission in a MT-EDT procedure, while there may be multiple DL (data) transmissions during/in a MT-SDT procedure. The UE may receive the (subsequent) DL data/transmission in dynamic DL assignment(s) provided by the NW. The UE may receive the (subsequent) DL data/transmission in (pre-)configured Physical Downlink Shared Channel (PDSCH) resources (e.g., by DL Semi-Persistent Scheduling (SPS)). The DL SPS may be applied in RRC_INACTIVE state.

In response to DL data (e.g., small data) available for transmission while the UE is in RRC_INACTIVE state, the NW could indicate the UE (e.g., via paging) to initiate a MT-SDT procedure. To perform MT-SDT in NR, the NW could send a paging including MT-SDT indication to the UE. In response to the reception of the paging indicating MT-SDT, the UE could initiate/trigger a MT-SDT procedure. The UE may need to send a RRC message to the NW before receiving DL data. The UE may receive DL data directly after receiving the paging. The UE would monitor Physical Downlink Control Channel (PDCCH) in the paging occasions. The UE would start to monitor PDCCH in response to receiving the paging. The UE would continue monitoring PDCCH during the time duration from receiving the paging indicating MT-SDT to completion of the MT-SDT (e.g., the MT-SDT procedure is terminated).

The UE would initiate/trigger a RRC Resume procedure for a MT-SDT procedure. The UE may transmit a RRC Resume Request message (e.g., RRCResumeRequest) in a RA procedure. The UE may transmit a RRC Resume Request message (e.g., RRCResumeRequest) using RA resources and/or pre-configured PUSCH resources. The RA procedure may be a normal RA and/or RA-SDT. The pre-configured PUSCH resources may be CG-SDT resources. The UE may transmit a RRC Resume Request message (e.g., RRCResumeRequest) in a Msg3, Message B (MSGB) and/or PDU to be transmitted using CG-SDT resources. The UE may receive a DL (data) transmission in response to the transmission of RRC Resume Request message (e.g., RRCResumeRequest). The UE may receive the DL (data) transmission in a dynamic grant and/or pre-configured PDSCH resources. The UE may receive the DL (data) transmission using DL SPS.

The NW may send a paging to indicate the UE (e.g., in RRC_INACTIVE state) to perform MT-SDT when the NW has DL data to transmit. The UE may receive a paging indicating MT-SDT. The UE may receive a paging message (e.g., paging) with a parameter (e.g., mt-SDT as TRUE) to indicate MT-SDT. The UE may receive a Downlink Control Information (DCI) and/or PDCCH indicating MT-SDT.

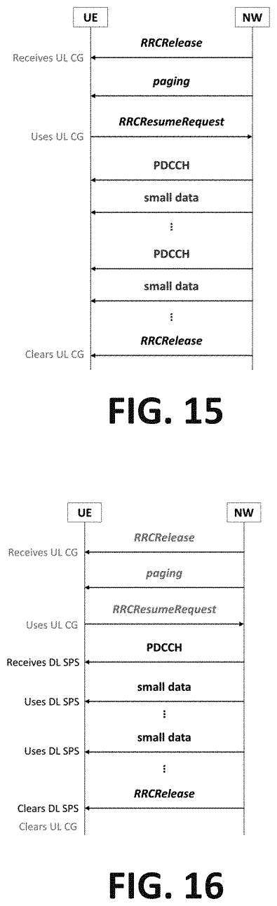

There may be multiple DL (data) transmission(s) during/in a MT-SDT procedure. The DL (data) transmission(s) during/in the MT-SDT procedure may be small and infrequent packet(s). For example, as shown in FIG. 15, the NW may configure and/or provide Type 1 configured (UL) grant (e.g., CG-SDT resources) in a first RRC Release message (e.g., RRCRelease). In response to receiving the first RRC Release message (e.g., RRCRelease), the UE may transition to RRC_INACTIVE state. The NW may transmit a paging (e.g., paging message) to indicate MT-SDT, e.g., when there are DL small data to transmit. In response to receiving the paging indicating MT-SDT, the UE may use the configured UL grant to transmit a RRC resume request message (e.g., RRCResumeRequest). After receiving the RRC resume request message (e.g., RRCResumeRequest), the NW may send multiple PDCCHs to schedule each PDSCH transmission for the multiple DL (small data) transmissions. When receiving a second RRC Release message (e.g., RRCRelease) in the end of the SDT procedure, the UE may reset MAC and clear the configured UL grant.

It would be beneficial for the UE to use dedicated resources and/or pre-configured PDSCH resources (e.g., DL SPS resources) to receive the DL data in RRC_INACTIVE state. The UE could activate and/or (re-)initialize a DL SPS for DL transmission(s) in MT-SDT. When the UE activates DL SPS, the UE stores a DL assignment (for the serving cell) and the associated Hybrid Automatic Repeat Request (HARQ) information as configured DL assignment, and (re-)initializes the configured DL assignment to start in the associated PDSCH duration. After a DL SPS is activated and/or (re-)initialized, the UE would consider the configured/stored DL assignment to recur and/or occur based on a pre-defined rule (e.g., in the slot according to rules in TS 38.321 ([4] 3GPP TS 38.321 V16.7.0, “NR, Medium Access Control (MAC) protocol specification”, clause 5.8.1). When the UE activates DL SPS, the UE may resume the DL transmission reception based on the DL SPS configuration. When the UE activates and/or initiates DL SPS, the UE may receive DL transmission using the DL SPS resources. When the UE deactivates DL SPS, the UE may suspend the DL transmission reception based on the DL SPS configuration.

For example, the UE may initiate a MT-SDT procedure in response to receiving a paging. The UE may initiate/trigger a RRC Resume procedure for the MT-SDT procedure. The UE may transmit a first/initial UL (data) transmission (e.g., with RRCResumeRequest) using RA-SDT/CG-SDT resources during/in the MT-SDT procedure. In response to/after transmitting the first/initial UL (data) transmission, the UE may receive a first DL (data) transmission using a dynamic assignment and/or a DL SPS. After receiving the first DL (data) transmission, the UE may receive subsequent DL (data) transmissions using the DL SPS. The UE may be configured with DL SPS when the UE is in RRC_CONNECTED state and/or RRC_INACTIVE state. The UE may receive the DL SPS configuration, a configured DL assignment and/or DL SPS resources. The UE may receive one or multiple DL SPS configuration (e.g., on a Bandwidth Part (BWP)). The DL SPS configuration may comprise the configured DL assignment and/or DL SPS resources. The configured DL assignment may be referred to the DL SPS resources. The UE may be activated to (start to) receive DL (data) transmissions using the DL SPS. The UE may be deactivated to stop receiving DL (data) transmission using the DL SPS.

For example, as shown in FIG. 16, the NW may configure and/or provide Type 1 configured (UL) grant (e.g., CG-SDT resources) in a first RRC Release message (e.g., RRCRelease). In response to receiving the first RRC Release message (e.g., RRCRelease), the UE may transition to RRC_INACTIVE state. The NW may transmit a paging (e.g., paging message) to indicate MT-SDT, e.g., when there are DL small data to transmit. In response to receiving the paging indicating MT-SDT, the UE may use the configured UL grant to transmit a RRC resume request message (e.g., RRCResumeRequest). After receiving the RRC resume request message (e.g., RRCResumeRequest), the NW may send a PDCCH to configure, activate, indicate and/or provide DL SPS (e.g., configured DL assignment) for the multiple DL (small data) transmissions. When receiving a second RRC Release message (e.g., RRCRelease) in the end of the SDT procedure, the UE may reset MAC and clear the configured UL grant and configured DL assignment.

The UE may receive one or more DL SPS configurations and/or DL SPS resources in a RRC message (e.g., a RRCRelease when transitioning the UE from RRC_CONNECTED state to RRC_INACTIVE state, a RRCReconfiguration in RRC_CONNECTED state). The UE may receive the DL SPS configuration(s) and/or DL SPS resources in a system information (e.g., a System Information Block (SIB) in the RRC_INACTIVE state). The UE may receive the DL SPS configuration(s) and/or DL SPS resources in a paging (e.g., in the RRC_INACTIVE state). The UE may receive the DL SPS configuration(s) and/or DL SPS resources in a Msg4, and/or MSGB (e.g., in the RA procedure triggered for MT-SDT).

The UE may receive an indication of activation of DL SPS on PDCCH. The (indication of) activation of DL SPS may be indicated in the PDCCH contents with a DL assignment. The (indication of) activation of DL SPS may be received on a PDCCH occasion. The (indication of) activation of DL SPS may be with a New Data Indicator (NDI) as 0. The downlink assignment may be addressed to Configured Scheduling-Radio Network Temporary Identifier (CS-RNTI), RNTI used in RRC_INACTIVE state, and/or RNTI used for MT-SDT. The UE may receive the DL assignment on the PDCCH. The UE may receive the DL assignment in a RRC message (e.g., a RRCRelease when transitioning the UE from RRC_CONNECTED state to RRC_INACTIVE state). The UE may receive the DL assignment in a system information (e.g., a SIB in the RRC_INACTIVE state). The UE may receive the DL assignment in a paging (e.g., in the RRC_INACTIVE state). The UE may receive the DL assignment in a Msg4, and/or MSGB (e.g., in the RA procedure triggered for MT-SDT). Throughout the disclosure, the “DL assignment” may be (part of) the information of the DL assignment received on the PDCCH. Throughout the disclosure, the DL assignment may indicate a transmission on a DL-SCH and/or provide relevant HARQ information. Throughout the disclosure, the “DL assignment” may indicate and/or be referred to the PDSCH resources (e.g., for DL SPS, for MT-SDT), and/or configured DL assignment (e.g., for DL SPS, in RRC_INACTIVE state).

The UE may receive an indication of deactivation of DL SPS on PDCCH. The (indication of) deactivation of DL SPS may be indicated in the PDCCH contents. The (indication of) deactivation of DL SPS may be received on a PDCCH occasion. The (indication of) deactivation of DL SPS may be with an NDI as 0. If the PDCCH contents indicate SPS deactivation, the UE may clear the configured DL assignment. However, the PDCCH indication of deactivation of the DL SPS may not always be received by the UE during/in a MT-SDT procedure. The NW may not transmit the (indication of) DL SPS deactivation in the end of a MT-SDT procedure. The UE may need to handle the failure in the MT-SDT procedure. The UE may terminate the MT-SDT procedure without NW indication. As a result, the UE would need to determine when to terminate the MT-SDT procedure and/or deactivate a DL SPS.

When non-SDT data arrives during a MT-SDT procedure, the UE may inform the NW by a UE assistance information (UAI). The NW may transmit a RRC resume message (e.g., RRCResume) to the UE. In response to receiving the RRC resume message (e.g., RRCResume), the UE may enter RRC_CONNECTED state and clear the configured UL grant by considering a TA timer for CG-SDT (e.g., cg-SDT-TimeAlignmentTimer) as expired. However, the UE would need to determine whether to clear the configured DL assignment in response to receiving the RRC resume message (e.g., RRCResume).

The UE could terminate a MT-SDT procedure and/or deactivate/release a DL SPS in response to (at least) one or more of the following conditions:
Receiving an indication on PDCCH (e.g., receiving an indication of DL SPS deactivation on PDCCH);
Receiving a RRC message (e.g., RRCRelease, RRCResume, a RRC message to terminate the MT-SDT procedure);
Receiving another paging (e.g., a paging not indicating MT-SDT, a Radio Access Network (RAN) paging, a paging indicating non-SDT DL data arrival);
Timer expiry (e.g., expiry of a failure detection timer, a PDCCH monitoring timer and/or a TA timer);
(All) DL Synchronization Signal Block(s) (SSB(s)) (e.g., used for/associated with DL SPS, used for/associated with DL transmission during/in the MT-SDT procedure) is/becomes not qualified;
Cell reselection;
Initiating RRC Resume procedure from another cell;
Reception failure (e.g., via DL SPS resource) up to a configured time (e.g., failing to decode received data up to a configured time); and/or
Non-SDT UL data arrival (e.g., and/or transmitting an UAI to indicate NW).

In response to terminating a MT-SDT procedure and/or deactivating/releasing a DL SPS, the UE could perform (at least) one or more of the following behaviors:
Releasing the DL SPS resources;
Flushing soft buffers for DL HARQ processes;
Clearing the configured DL assignment;
Keeping the DL SPS configuration(s) (e.g., not releasing the DL SPS configuration(s));
Stopping monitoring PDCCH;
Transmitting an indication (e.g., an Uplink Control Information (UCI), an UAI, a MAC Control Element (CE), a RRC message) to NW, e.g., to notify the above condition(s) or failure of MT-SDT and/or DL SPS;
Initiating a legacy RA procedure;
Initiating a MO-SDT procedure (e.g., RA-SDT, CG-SDT); and/or
Transitioning to RRC_IDLE state.

The UE could deactivate/release a DL SPS and/or terminate a MT-SDT procedure in response to receiving an indication on PDCCH (e.g., DL SPS deactivation). The indication may be a DL SPS deactivation. The DL SPS deactivation may be received/indicated on PDCCH. The indication may be a dynamic DL assignment. The dynamic DL assignment may replace or overwrite the DL SPS.

For example, the UE may initiate a MT-SDT procedure in response to receiving a paging. The UE may initiate/trigger a RRC Resume procedure for the MT-SDT procedure. The UE may transmit a first/initial UL (data) transmission (e.g., with RRCResumeRequest) using RA-SDT/CG-SDT resources during/in the MT-SDT procedure. In response to/after transmitting the first/initial UL (data) transmission, the UE may receive one or more DL (data) transmissions using DL SPS. The UE may receive a dynamic DL assignment (e.g., to replace or overwrite the DL SPS). The UE may receive a PDCCH indicating deactivation of DL SPS (e.g., when NW has no DL data to transmit).

In response to receiving the indication on PDCCH (e.g., DL SPS deactivation), the UE may or may not perform one or more of the following actions. The UE may terminate the MT-SDT procedure. The UE may deactivate DL SPS. The UE may stop receiving DL (data) transmission using the DL SPS. The UE may release the DL SPS resources. The UE may not release the DL SPS resources. The UE may flush soft buffers for DL HARQ processes. The UE may not flush soft buffers for DL HARQ processes. The UE may clear the configured DL assignment for DL SPS. The UE may not clear the configured DL assignment for DL SPS. The UE may release one or more DL SPS configuration(s). The UE may not release the DL SPS configuration(s). The UE may keep the DL SPS configuration(s). The UE may release the DL SPS configuration(s) indicated by the indication on PDCCH (e.g., DL SPS deactivation). The UE may not release the DL SPS configuration(s) not indicated by the indication on PDCCH (e.g., DL SPS deactivation). The UE may stop monitoring PDCCH. The UE may not stop monitoring PDCCH. The UE may stay in RRC_INACTIVE state. The UE may transition to RRC_IDLE state. The UE may transition to RRC_CONNECTED state. The UE may perform RRC state transition with NW response (e.g., RRCRelease, RRCResume). The UE may perform RRC state transition without NW response.

The UE could deactivate/release a DL SPS and/or terminate a MT-SDT procedure in response to receiving a RRC message (e.g., RRCRelease, RRCResume, a RRC message to terminate the MT-SDT procedure).

For example, the UE may initiate a MT-SDT procedure in response to receiving a paging. The UE may initiate/trigger a RRC Resume procedure for the MT-SDT procedure. The UE may transmit a first/initial UL (data) transmission (e.g., with RRCResumeRequest) using RA-SDT/CG-SDT resources during/in the MT-SDT procedure. In response to/after transmitting the first/initial UL (data) transmission, the UE may receive one or more DL (data) transmissions using DL SPS. The UE may receive a RRC message in (the end of) the MT-SDT procedure. The RRC message may be a Release message (e.g., RRCRelease), a Resume message (e.g., RRCResume), and/or a RRC message to terminate the MT-SDT procedure.

In response to receiving the RRC message, the UE may or may not perform one or more of the following actions. The UE may deactivate the DL SPS. The UE may stop receiving DL (data) transmission using the DL SPS. The UE may release the DL SPS resources. The UE may not release the DL SPS resources. The UE may release the DL SPS resources if the RRC message indicates to release the DL SPS resources. The UE may release the DL SPS resources if the RRC message indicates RRC state transition. The UE may not release the DL SPS resources if the RRC message indicates not to release the DL SPS resources. The UE may not release the DL SPS resources if the RRC message indicates the UE stay in RRC_INACTIVE state (e.g., with a RRCRelease with suspendConfig). The UE may flush soft buffers for DL HARQ processes. The UE may not flush soft buffers for DL HARQ processes. The UE may clear the configured DL assignment for DL SPS. The UE may not clear the configured DL assignment for DL SPS. Not clearing the configured DL assignment for DL SPS could mean to keep (using) the configured DL assignment for DL SPS. The UE may release the DL SPS configuration(s). The UE may not release the DL SPS configuration(s). The UE may keep the DL SPS configuration(s). The UE may release one or more DL SPS configuration(s) if the RRC message indicates to release the DL SPS configuration(s). The UE may release the DL SPS configuration(s) if the RRC message indicates RRC state transition. The UE may not release one or more DL SPS configuration(s) if the RRC message indicates not to release the DL SPS configuration(s). The UE may not release the DL SPS configuration(s) if the RRC message indicates the UE stay in RRC_INACTIVE state (e.g., a RRCRelease with suspendConfig). The UE may stop monitoring PDCCH. The UE may not stop monitoring PDCCH. The UE may terminate the MT-SDT procedure. The UE may stay in RRC_INACTIVE state if the RRC message is a RRC release message (e.g., RRCRelease) with suspend configuration (e.g., suspendConfig). The UE may transition to RRC_IDLE state if the RRC message is a RRC release message (e.g., RRCRelease) without suspend configuration (e.g., suspendConfig). The UE may transition to RRC_CONNECTED state if the RRC message is a RRC resume message (e.g., RRCResume). In response to receiving a RRC resume message (e.g., RRCResume), the UE may transition to RRC_CONNECTED state and clear the configured DL assignment for DL SPS. In response to receiving a RRC resume message (e.g., RRCResume), the UE may transition to RRC_CONNECTED state and not clear the configured DL assignment for DL SPS (e.g., keep using the configured DL assignment for DL SPS when the UE is in RRC_CONNECTED state). In response to receiving a RRC resume message (e.g., RRCResume), the UE may consider a TA timer (e.g., legacy TA timer, TA timer for CG-SDT) as expired.

The UE could deactivate/release a DL SPS and/or terminate a MT-SDT procedure in response to receiving another paging (e.g., other than the paging that initiates the MT-SDT procedure, a paging not indicating MT-SDT, a RAN paging, a paging indicating non-SDT DL data arrival).

For example, the UE may initiate a MT-SDT procedure in response to receiving a first paging. The UE may initiate/trigger a RRC Resume procedure for the MT-SDT procedure. The UE may transmit a first/initial UL (data) transmission (e.g., with RRCResumeRequest) using RA-SDT/CG-SDT resources during/in the MT-SDT procedure. In response to/after transmitting the first/initial UL (data) transmission, the UE may receive one or more DL (data) transmissions using DL SPS. The UE may receive a second paging during the MT-SDT procedure. The second padding may be a paging not indicating MT-SDT, a RAN paging, a paging indicating non-SDT DL data arrival, and/or a paging initiating another RRC Resume procedure.

In response to receiving the second paging, the UE may or may not perform one or more of the following actions. The UE may deactivate the DL SPS. The UE may stop receiving DL (data) transmission using the DL SPS. The UE may release the DL SPS resources. The UE may not release the DL SPS resources. The UE may flush soft buffers for DL HARQ processes. The UE may not flush soft buffers for DL HARQ processes. The UE may clear the configured DL assignment for DL SPS. The UE may not clear the configured DL assignment for DL SPS. The UE may release the DL SPS configuration(s). The UE may not release the DL SPS configuration(s). The UE may keep the DL SPS configuration(s). The UE may stop monitoring PDCCH. The UE may not stop monitoring PDCCH. The UE may terminate the MT-SDT procedure. The UE may terminate the RRC Resume procedure and/or initiate another RRC Resume procedure. The UE may initiate a legacy RA. The UE may transition to RRC_IDLE state. The UE may transition to RRC_CONNECTED state. The UE may perform RRC state transition with NW response (e.g., RRCRelease, RRCResume). The UE may perform RRC state transition without NW response. The UE may perform RRC state transition in response to receiving the second paging and/or initiating the legacy RA.

The UE could deactivate/release a DL SPS and/or terminate a MT-SDT procedure in response to a timer expiry (e.g., expiry of a failure detection timer, expiry of a PDCCH monitoring timer and/or expiry of a TA timer).

For example, the UE may initiate a MT-SDT procedure in response to receiving a paging. The UE may initiate/trigger a RRC Resume procedure for the MT-SDT procedure. The UE may transmit a first/initial UL (data) transmission (e.g., with RRCResumeRequest) using RA-SDT/CG-SDT resources during/in the MT-SDT procedure. In response to/after transmitting the first/initial UL (data) transmission, the UE may receive one or more DL (data) transmissions using DL SPS. The UE may start a timer in/during the MT-SDT procedure.

The timer may be a failure detection timer. The failure detection timer may be the timer to handle failure of RRC Resume procedure, MO-SDT procedure and/or MT-SDT procedure. The failure detection timer may be started upon transmission of a first RRC message (e.g., RRCResumeRequest, RRCResumeRequest1). The failure detection timer may be stopped upon reception of a second RRC message (e.g., RRCResume, RRCSetup, RRCRelease, RRCReject). When the failure detection timer expires, the UE may consider failure of a RRC Resume and/or MT-SDT procedure.

The timer may be a PDCCH monitoring timer. The PDCCH monitoring timer may be the timer to control the UE's PDCCH monitoring. When the PDCCH monitoring timer is running, the UE may monitor PDCCH.

The timer may be a TA timer (e.g., legacy TA timer, TA timer for CG-SDT, TA timer for MT-SDT). The TA timer may be the timer that controls how long the UE considers the Serving Cell, the UL transmission for CG-SDT and/or the UL transmission for MT-SDT to be UL time aligned. When the TA timer is running, the UE may consider the TA is valid.

In response to the timer expiry, the UE may or may not perform one or more of the following actions. The UE may deactivate the DL SPS. The UE may stop receiving DL (data) transmission using the DL SPS. The UE may release the DL SPS resources. The UE may not release the DL SPS resources. The UE may release the DL SPS resources if the timer is the failure detection timer (and/or if the failure detection timer expires). The UE may release the DL SPS resources if the timer is the TA timer (and/or if the TA timer expires). The UE may not release the DL SPS resources if the timer is the TA timer (and/or if the TA timer expires). The UE may not release the DL SPS resources if the timer is the PDCCH monitoring timer (and/or if the PDCCH monitoring timer expires). The UE may clear the configured DL assignment for DL SPS. The UE may not clear the configured DL assignment for DL SPS. Not clearing the configured DL assignment for DL SPS could mean to keep (using) the configured DL assignment for DL SPS. The UE may release the DL SPS configuration(s). The UE may not release the DL SPS configuration(s). The UE may keep the DL SPS configuration(s). The UE may release the DL SPS configuration(s) corresponding to the timer (e.g., PDCCH monitoring timer, TA timer). The UE may not release the DL SPS configuration(s) not corresponding to the timer (e.g., PDCCH monitoring timer, TA timer). The UE may flush soft buffers for DL HARQ processes. The UE may not flush soft buffers for DL HARQ processes. The UE may stop monitoring PDCCH. The UE may not stop monitoring PDCCH. The UE may terminate the MT-SDT procedure. The UE may not terminate the MT-SDT procedure. The UE may transmit an indication to the NW, e.g., to notify the timer expiry, or failure of MT-SDT and/or DL SPS. The UE may initiate a legacy RA procedure (to indicate NW). The UE may indicate to the NW that the TA is not valid. The UE may indicate to the NW to recover the TA. The UE may indicate MT-SDT failure to the NW. The indication may be an UCI, an UAI and/or a MAC CE. The UE may stay in RRC_INACTIVE state. The UE may transition to RRC_IDLE state. The UE may transition to RRC_CONNECTED state. The UE may perform RRC state transition with the NW response (e.g., RRCRelease, RRCResume). The UE may perform RRC state transition without the NW response. The UE may perform RRC state transition in response to the timer expiry. In response to the timer expiry, the UE may clear the configured DL assignment for DL SPS. In response to the timer expiry, the UE may not clear the configured DL assignment for DL SPS.

The UE could deactivate/release a DL SPS and/or terminate a MT-SDT procedure in response to a (or all) DL SSB(s) (e.g., associated with the DL SPS) becomes not qualified (e.g., the Reference Symbol Received Power (RSRP) of the DL SSB becomes below a RSRP threshold). The NW may configure DL SSB(s) for each DL SPS resources. The SSB may refer to a beam. The UE may select any DL SSB among the configured DL SSBs to receive DL (data) transmission using DL SPS. The UE may select a DL SSB with radio condition (e.g., RSRP, Channel State Information Reference Signal (CSI-RS)) above and/or equal to a first threshold among the configured DL SSBs, to receive DL (data) transmission using DL SPS. The UE may use an indicated DL SSB among the configured DL SSBs to receive DL (data) transmission using DL SPS. The UE may evaluate/re-evaluate the radio condition of the DL SSB used for receiving DL (data) transmission during the MT-SDT procedure. The UE may compare the radio condition (e.g., RSRP, CSI-RS) of the DL SSB used for receiving DL (data) transmission with a second threshold during the MT-SDT procedure. The first threshold and the second threshold may be the threshold of RSRP or CSI-RS. The first threshold and the second threshold may be the same threshold. The first threshold and the second threshold may be different thresholds.

For example, the UE may initiate a MT-SDT procedure in response to receiving a paging. The UE may initiate/trigger a RRC Resume procedure for the MT-SDT procedure. The UE may transmit a first/initial UL (data) transmission (e.g., with RRCResumeRequest) using RA-SDT/CG-SDT resources during/in the MT-SDT procedure. In response to/after transmitting the first/initial UL (data) transmission, the UE may receive one or more DL (data) transmissions using DL SPS. The UE may evaluate the radio condition (e.g., RSRP, CSI-RS) of a DL SSB upon receiving the paging and/or initiating/triggering the MT-SDT procedure. The UE may evaluate the radio condition (e.g., RSRP, CSI-RS) of a DL SSB in response to transmitting the first/initial UL (data) transmission. The UE may evaluate the radio condition (e.g., RSRP, CSI-RS) of a DL SSB before receiving the first DL (data) transmission. The UE may evaluate the radio condition (e.g., RSRP, CSI-RS) of a DL SSB before receiving subsequent DL (data) transmission(s). The UE may evaluate the radio condition (e.g., RSRP, CSI-RS) of a DL SSB before using DL SPS (resources). The DL SSB (e.g., used for DL SPS) may be and/or become not qualified during the MT-SDT procedure. The radio condition (e.g., RSRP, CSI-RS) of the DL SSB (e.g., used for DL SPS) may be and/or become below and/or equal to a threshold during the MT-SDT procedure. A DL SSB may be not qualified when the radio condition (e.g., RSRP, CSI-RS) of the DL SSB is below and/or equal to a threshold. A DL SSB may be not qualified when the radio condition (e.g., RSRP, CSI-RS) of the DL SSB is not above a threshold.

In response to a or all DL SSBs (e.g., used for DL SPS) not qualified, the UE may or may not perform one or more of the following actions. The UE may deactivate the DL SPS. The UE may stop receiving DL (data) transmission using the DL SPS. The UE may release the DL SPS resources. The UE may not release the DL SPS resources. The UE may flush soft buffers for DL HARQ processes. The UE may not flush soft buffers for DL HARQ processes. The UE may clear the configured DL assignment for DL SPS. The UE may not clear the configured DL assignment for DL SPS. The UE may release the DL SPS configuration(s). The UE may not release the DL SPS configuration(s). The UE may keep the DL SPS configuration(s). The UE may release the DL SPS configuration(s) corresponding to the not qualified DL SSB. The UE may not release the DL SPS configuration(s) not corresponding to the not qualified DL SSB. The UE may release a DL SPS configuration if all DL SSBs configured for the DL SPS configuration are not qualified. The UE may release a DL SPS configuration if one of the DL SSBs configured for the DL SPS configuration are not qualified. The UE may release the DL SPS configurations if all DL SSBs configured for a DL SPS configurations are not qualified. The UE may stop monitoring PDCCH. The UE may not stop monitoring PDCCH. The UE may terminate the MT-SDT procedure. The UE may not terminate the MT-SDT procedure. The UE may transmit an indication to the NW, e.g., to notify the SSB(s) being not qualified, or failure of MT-SDT and/or DL SPS. The UE may initiate a legacy RA procedure (to indicate the NW). The UE may initiate a RA-SDT and/or CG-SDT procedure (to indicate NW). The UE may indicate MT-SDT failure to the NW. The UE may indicate beam failure to the NW. The UE may request beam recovery from the NW. The indication may be an UCI, an UAI and/or a MAC CE. The UE may stay in RRC_INACTIVE state. The UE may transition to RRC_IDLE state. The UE may transition to RRC_CONNECTED state. The UE may perform RRC state transition with the NW response (e.g., RRCRelease, RRCResume). The UE may perform RRC state transition without the NW response. The UE may perform RRC state transition in response to the one or all DL SSBs (e.g., used for DL SPS) becomes not qualified.

The UE could deactivate/release a DL SPS and/or terminate a MT-SDT procedure in response to moving and/or linking to another cell (e.g., changing its serving cell, cell reselection). The UE could deactivate a DL SPS and/or terminate a MT-SDT procedure in response to initiating a RRC resume procedure from another cell. The UE could deactivate a DL SPS and/or terminate a MT-SDT procedure in response to moving to (and/or initiating a RRC resume procedure from) a cell different from the cell the UE received the DL SPS configuration(s). The UE could deactivate a DL SPS and/or terminate a MT-SDT procedure in response to moving to (and/or initiating a RRC resume procedure from) a cell different from the cell the UE transitions to RRC_INACTIVE state from RRC_CONNECTED state. The UE could deactivate a DL SPS and/or terminate a MT-SDT procedure in response to moving to (and/or initiating a RRC resume procedure from) a cell different from the cell the UE initiates/triggers the MT-SDT procedure. The UE could deactivate a DL SPS and/or terminate a MT-SDT procedure in response to performing cell reselection.

For example, the UE may initiate a MT-SDT procedure in response to receiving a paging in a first cell. The UE may initiate/trigger a first RRC Resume procedure for the MT-SDT procedure. The UE may transmit a first/initial UL (data) transmission (e.g., with RRCResumeRequest) using RA-SDT/CG-SDT resources during/in the MT-SDT procedure. In response to/after transmitting the first/initial UL (data) transmission, the UE may receive one or more DL (data) transmissions using DL SPS. The UE may move to a second cell during the MT-SDT procedure. The UE may perform cell reselection. The UE may initiate/trigger a second RRC Resume procedure in the second cell.

In response to moving to the second cell (e.g., and/or linking to the second cell, performing cell reselection to the second cell, initiating/triggering the second RRC Resume procedure in the second cell), the UE may or may not perform one or more of the following actions. The UE may deactivate the DL SPS. The UE may stop receiving DL (data) transmission using the DL SPS. The UE may release the DL SPS resources. The UE may not release the DL SPS resources. The UE may flush soft buffers for DL HARQ processes. The UE may not flush soft buffers for DL HARQ processes. The UE may clear the configured DL assignment for DL SPS. The UE may not clear the configured DL assignment for DL SPS. The UE may release the DL SPS configuration(s). The UE may not release the DL SPS configuration(s). The UE may keep the DL SPS configuration(s). The UE may stop monitoring PDCCH. The UE may not stop monitoring PDCCH. The UE may terminate the MT-SDT procedure. The UE may initiate/trigger another MT-SDT procedure in the second cell. The UE may initiate a legacy RA procedure. The UE may initiate the second RRC Resume procedure. The UE may stay in RRC_INACTIVE state. The UE may transition to RRC_IDLE state. The UE may transition to RRC_CONNECTED state. The UE may perform RRC state transition with the NW response (e.g., RRCRelease, RRCResume). The UE may perform RRC state transition without the NW response. The UE may perform RRC state transition in response to moving to the second cell, linking to the second cell, performing cell reselection to the second cell, and/or initiating/triggering the second RRC Resume procedure in the second cell.

The UE could deactivate/release a DL SPS and/or terminate a MT-SDT procedure in response to repeated transmission failures (e.g., failing to decode received DL data (e.g., via DL SPS resource, MAC PDU, Radio Link Control (RLC) PDU) up to a configured time.

For example, the UE may initiate a MT-SDT procedure in response to receiving a paging. The UE may initiate/trigger a RRC Resume procedure for the MT-SDT procedure. The UE may transmit a first/initial UL (data) transmission (e.g., with RRCResumeRequest) using RA-SDT/CG-SDT resources during/in the MT-SDT procedure. In response to/after transmitting the first/initial UL (data) transmission, the UE may receive one or more DL (data) transmissions using DL SPS. The UE may fail to decode one or more received DL data in/during the MT-SDT procedure.

In response to repeated transmission failure (e.g., failing to decode received DL data (e.g., MAC PDU, RLC PDU) up to a configured time (e.g., a configured threshold)), the UE may or may not perform one or more of the following actions. The UE may deactivate the DL SPS. The UE may stop receiving DL (data) transmission using the DL SPS. The UE may release the DL SPS resources. The UE may not release the DL SPS resources. The UE may flush soft buffers for DL HARQ processes. The UE may not flush soft buffers for DL HARQ processes. The UE may clear the configured DL assignment for DL SPS. The UE may not clear the configured DL assignment for DL SPS. The UE may release the DL SPS configuration(s). The UE may not release the DL SPS configuration(s). The UE may keep the DL SPS configuration(s). The UE may release the DL SPS configuration(s) corresponding to the DL HARQ process on which the repeated transmission failure occurs. The UE may not release the DL SPS configuration(s) not corresponding to the DL HARQ process on which the repeated transmission failure occurs. The UE may stop monitoring PDCCH. The UE may not stop monitoring PDCCH. The UE may terminate the MT-SDT procedure. The UE may not terminate the MT-SDT procedure. The UE may transmit an indication to the NW, e.g., to notify the reception failure, or failure of MT-SDT and/or DL SPS. The UE may initiate a legacy RA procedure (to indicate NW). The UE may initiate a RA-SDT and/or CG-SDT procedure (to indicate the NW). The UE may indicate MT-SDT failure to the NW. The UE may indicate beam failure to the NW. The UE may request beam recovery from the NW. The indication may be an UCI, an UAI and/or a MAC CE. The UE may stay in RRC_INACTIVE state. The UE may transition to RRC_IDLE state. The UE may transition to RRC_CONNECTED state. The UE may perform RRC state transition with the NW response (e.g., RRCRelease, RRCResume). The UE may perform RRC state transition without the NW response. The UE may perform RRC state transition in response to failing to decode received DL data up to a configured time.

The UE could deactivate/release a DL SPS and/or terminate a MT-SDT procedure in response to non-SDT UL data arrival. The UE could deactivate a DL SPS and/or terminate a MT-SDT procedure in response to transmitting a UAI to indicate non-SDT UL data arrival.

For example, the UE may initiate a MT-SDT procedure in response to receiving a paging. The UE may initiate/trigger a RRC Resume procedure for the MT-SDT procedure. The UE may transmit a first/initial UL (data) transmission (e.g., with RRCResumeRequest) using RA-SDT/CG-SDT resources during/in the MT-SDT procedure. In response to/after transmitting the first/initial UL (data) transmission, the UE may receive one or more DL (data) transmissions using DL SPS. There may be non-SDT UL data arrives at the UE during the MT-SDT procedure. The non-SDT UL data may be the data that belongs to a LCH (logical channel) which is not allowed to be transmitted by SDT procedure (e.g., configured by the NW). The non-SDT UL data may be the data that belongs to a Data Radio Bearer (DRB) and/or Signaling Radio Bearer (SRB) not configured for SDT. The SDT UL data may be the data that belongs to a LCH (logical channel) which is allowed to be transmitted by SDT procedure (e.g., configured by the NW). The SDT UL data may be the data that belongs to a DRB and/or SRB configured for SDT.

In response to non-SDT UL data arrival during a MT-SDT procedure, the UE may inform the NW, e.g., by transmitting a UAI. The UAI may or may not comprise a resume cause (e.g., ResumeCause). In response to non-SDT UL data arrival and/or transmitting the UAI, the UE may or may not perform one or more of the following actions. The UE may deactivate the DL SPS. The UE may stop receiving DL (data) transmission using the DL SPS. The UE may release the DL SPS resources. The UE may not release the DL SPS resources. The UE may flush soft buffers for DL HARQ processes. The UE may not flush soft buffers for DL HARQ processes. The UE may clear the configured DL assignment for DL SPS. The UE may not clear the configured DL assignment for DL SPS. The UE may release the DL SPS configuration(s). The UE may not release the DL SPS configuration(s). The UE may keep the DL SPS configuration(s). The UE may stop monitoring PDCCH. The UE may not stop monitoring PDCCH. The UE may terminate the MT-SDT procedure. The UE may initiate a legacy RA procedure (to indicate the NW). The UE may stay in RRC_INACTIVE state. The UE may transition to RRC_IDLE state. The UE may transition to RRC_CONNECTED state. The UE may perform RRC state transition with the NW response (e.g., RRCRelease, RRCResume). The UE may perform RRC state transition without the NW response. The UE may perform RRC state transition in response to non-SDT UL data arrival.

The UE could deactivate a DL SPS and/or terminate a MT-SDT procedure in response to MT-SDT failure.

For example, the UE may initiate a MT-SDT procedure in response to receiving a paging. The UE may initiate/trigger a RRC Resume procedure for the MT-SDT procedure. The UE may transmit a first/initial UL (data) transmission (e.g., with RRCResumeRequest) using RA-SDT/CG-SDT resources during/in the MT-SDT procedure. In response to/after transmitting the first/initial UL (data) transmission, the UE may receive one or more DL (data) transmissions using DL SPS. The MT-SDT procedure may be considered as failure in response to (at least) one or more of the following conditions:
Receiving another paging (e.g., a paging different from the paging indicating MT-SDT, a RAN paging, a paging indicating non-SDT DL data arrival);
Timer expiry (e.g., expiry of a failure detection timer and/or a TA timer);
DL SSB (e.g., used for DL SPS, used for DL transmission during/in the MT-SDT procedure) is/becomes not qualified (e.g., the radio condition of the DL SSB is below or equal to a RSRP threshold);
Cell reselection;
Initiating RRC Resume procedure from another cell (e.g., the cell different from the UE initiate the MT-SDT procedure), e.g., to change serving cell; and/or
Repeated transmission failure (e.g., failing to decode received data up to a configured times).

In response to MT-SDT failure, the UE may or may not perform one or more of the following actions. The UE may deactivate the DL SPS. The UE may stop receiving DL (data) transmission using the DL SPS. The UE may release the DL SPS resources. The UE may not release the DL SPS resources. The UE may flush soft buffers for DL HARQ processes. The UE may not flush soft buffers for DL HARQ processes. The UE may clear the configured DL assignment for DL SPS. The UE may not clear the configured DL assignment for DL SPS. The UE may release the DL SPS configuration(s). The UE may not release the DL SPS configuration(s). The UE may keep the DL SPS configuration(s). The UE may stop monitoring PDCCH. The UE may not stop monitoring PDCCH. The UE may terminate the MT-SDT procedure. The UE may transmit an indication to the NW, e.g., to notify the reception failure, or failure of MT-SDT and/or DL SPS. The UE may initiate a legacy RA procedure (to indicate the NW). The UE may stay in RRC_INACTIVE state. The UE may transition to RRC_IDLE state. The UE may transition to RRC_CONNECTED state. The UE may perform RRC state transition with the NW response (e.g., RRCRelease, RRCResume). The UE may perform RRC state transition without the NW response. The UE may perform RRC state transition in response to MT-SDT failure.

Combinations of the examples herein in the disclosure are possible with various embodiments and concepts disclosed herein.

Throughout the disclosure, the “paging” may refer to a paging message (e.g., paging) and/or (a DCI on) the PDCCH addressed to a specific UE RNTI (e.g., Cell RNTI (C-RNTI), CS-RNTI, Paging RNTI (P-RNTI), a RNTI used in RRC_INACTIVE state, a RNTI used for MT-SDT). The specific UE RNTI may be a RNTI provided by the NW in RRC_CONNECTED state and/or RRC_INACTIVE state.

Throughout the disclosure, the RA-SDT procedure may be a RA procedure with UL data, a RA procedure using RA resources for MO-SDT. The legacy RA and/or normal RA may be a RA procedure without transmitting user data, a RA procedure using RA resources not for MO-SDT and/or a RA procedure using RA resources not for one or more (release 17) features such as (MO-)SDT, RedCap, slicing, coverage enhancement. Throughout the disclosure, the “RRC Resume procedure” may be referred to and/or replaced by “RRC connection resume procedure”. The DL SPS may be referred to as SPS. The “DL data transmission” may be “DL transmission”. The “UL data transmission” may be “UL transmission”.

Throughout the disclosure, the “SDT” may be, may be referred to, may be replaced by, and/or may be supplementary with “MO-SDT” and/or “MT-SDT.” The MO-SDT may be a SDT procedure triggered by the upper layer when UL small data arrival. The MT-SDT may be a SDT procedure triggered by a paging message when DL small data arrival. The UE may transmit and/or receive small data in RRC_INACTIVE state during a SDT procedure.

In a RRC Resume procedure form RRC_INACTIVE state, the UE would transmit a RRC resume request message (e.g., RRCResumeRequestIRRCResumeRequest1) to the NW. In response to receiving the RRC resume request message, the NW may transmit a RRC resume message (e.g., RRCResume) to the UE. In response to receiving the RRC resume message (e.g., RRCResume), the UE would transmit a RRC resume complete message (e.g., RRCresumeComplete) and transition to RRC_CONNECTED state. In response to receiving the RRC resume request message, the NW may transmit a RRC release message (e.g., RRCRelease) with suspend configuration (e.g., suspendConfig) to the UE. In response to receiving the RRC release message (e.g., RRCRelease) with suspend configuration (e.g., suspendConfig), the UE would stay in RRC_INACTIVE state. In response to receiving the RRC resume request message, the NW may transmit a RRC release message (e.g., RRCRelease) without suspend configuration (e.g., suspendConfig) to the UE. In response to receiving the RRC release message (e.g., RRCRelease) without suspend configuration (e.g., suspendConfig), the UE would transition to RRC_IDLE state. The RRC Resume procedure may be triggered/initiated in response to paging and/or initiating of a MT-SDT/MO-SDT procedure.

The UE may receive (and/or apply) some configuration(s) from the NW related to MO-SDT (e.g., CG-SDT/RA-SDT resources) and/or MT-SDT. The UE may receive (and/or apply) some configuration(s) from the NW related to DL SPS. The above configurations may be received in RRC_CONNECTED state. The configurations may be received in RRC_INACTIVE state. The configurations may be received in a RRC message (e.g., RRCReconfiguration, RRCRelease). The UE may receive and/or be configured with a DL assignment (indicating the PDSCH resources) for DL SPS. The UE may receive the DL assignment in/along with the above configuration(s). The UE may receive the DL assignment in a RRC message, system information, paging, and/or Msg3/MSGB. The DL assignment may indicate activation of DL SPS. The DL assignment may not indicate activation of DL SPS. The DL assignment may be stored and/or (re)used for DL transmission for DL SPS. The UE may consider a (configured/stored) DL assignment (e.g., the PDSCH resources) to recur and/or be reused based on a pre-defined rule/formula for DL SPS. The start slot of the (configured/stored) DL assignment (e.g., the PDSCH resources) may be the slot of the first transmission of PDSCH where the DL assignment is (re-)initialized. The start slot of the (configured/stored) DL assignment (e.g., the PDSCH resources) may be the slot of the DL assignment is received. The start slot of the (configured/stored) DL assignment (e.g., the PDSCH resources) may be the slot of the DL SPS configuration(s) is received. The start slot of the (configured/stored) DL assignment (e.g., the PDSCH resources) may be a slot indicated in the DL SPS configuration(s).

The UE may be referred to the UE, a MAC entity of the UE, and/or a RRC entity of the UE. The UE may be a NR device. The UE may be a NR-light device. The UE may be a reduced capability device. The UE may be a mobile phone. The UE may be a wearable device. The UE may be a sensor. The UE may be a stationary device.

The NW may be a network node. The NW may be a base station. The NW may be an access point. The NW may be an evolved Node B (eNB). The NW may be a NR Node B (gNB).

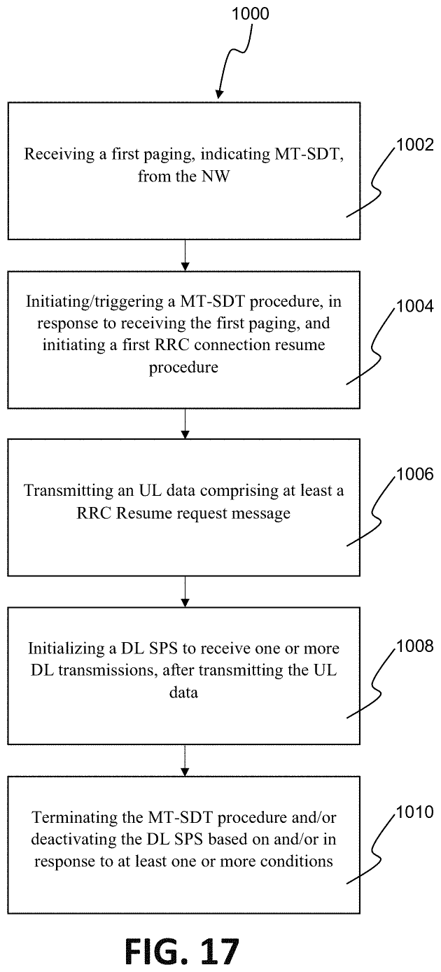

Referring to FIG. 17, with this and other concepts, systems, and methods of the present invention, a method 1000 for a UE in a wireless communication system comprises receiving a first paging, indicating MT-SDT, from the NW (step 1002), initiating/triggering a MT-SDT procedure, in response to receiving the first paging, and initiating a first RRC connection resume procedure (step 1004), transmitting an UL data comprising at least a RRC Resume request message (e.g., RRCResumeRequest) (step 1006), initializing a DL SPS to receive one or more DL transmissions, after transmitting the UL data (step 1008), and terminating the

MT-SDT procedure and/or deactivating the DL SPS based on and/or in response to at least one or more conditions (step 1010).

In various embodiments, the paging is a paging message and/or a PDCCH reception.

In various embodiments, the UE transmits the UL data in a RA procedure and/or using pre-configured PUSCH resources.

In various embodiments, the DL SPS is configured and activated by the NW.

In various embodiments, the condition is that the UE receives an indication on PDCCH.

In various embodiments, the condition is that the UE receives a RRC message.

In various embodiments, the condition is that the UE receives a second paging.

In various embodiments, the condition is that a timer (e.g., failure detection timer, PDCCH monitoring timer, TA timer) expires.

In various embodiments, the condition is that (all) DL SSB(s) associated with the DL SPS is/becomes not qualified.

In various embodiments, the condition is that the UE performs cell reselection.

In various embodiments, the condition is that the UE initiates a second RRC connection resume procedure.

In various embodiments, the condition is that reception failure up to a configured time.

In various embodiments, the condition is non-SDT UL data arrival.

Referring back to FIGS. 3 and 4, in one or more embodiments from the perspective of a UE, the device 300 includes a program code 312 stored in memory 310 of the transmitter. The CPU 308 could execute program code 312 to: (i) receive a first paging, indicating MT-SDT, from the NW; (ii) initiate/trigger a MT-SDT procedure, in response to receiving the first paging, and initiate a first RRC connection resume procedure; (iii) transmit an UL data comprising at least a RRC Resume request message (e.g., RRCResumeRequest); (iv) initialize a DL SPS to receive one or more DL transmissions, after transmitting the UL data; and (v) terminate the MT-SDT procedure and/or deactivate the DL SPS based on and/or in response to at least one or more conditions. Moreover, the CPU 308 can execute the program code 312 to perform all of the described actions, steps, and methods described above, below, or otherwise herein.

Referring again back to FIGS. 3 and 4, in one or more embodiments from the perspective of a NW, the device 300 includes a program code 312 stored in memory 310 of the transmitter. The CPU 308 could execute program code 312 to: (i) transmit a first paging, indicating MT-SDT, to a UE; (ii) initiate/trigger a MT-SDT procedure at the UE, in response to receiving the first paging, and initiate at the UE a first RRC connection resume procedure; (iii) receive an UL data comprising at least a RRC Resume request message (e.g., RRCResumeRequest); (iv) initialize a DL SPS at the UE to receive one or more DL transmissions, after the UL transmits the UL data; and (v) terminate at the UE the MT-SDT procedure and/or deactivate the DL SPS based on and/or in response to at least one or more conditions. Moreover, the CPU 308 can execute the program code 312 to perform all of the described actions, steps, and methods described above, below, or otherwise herein.

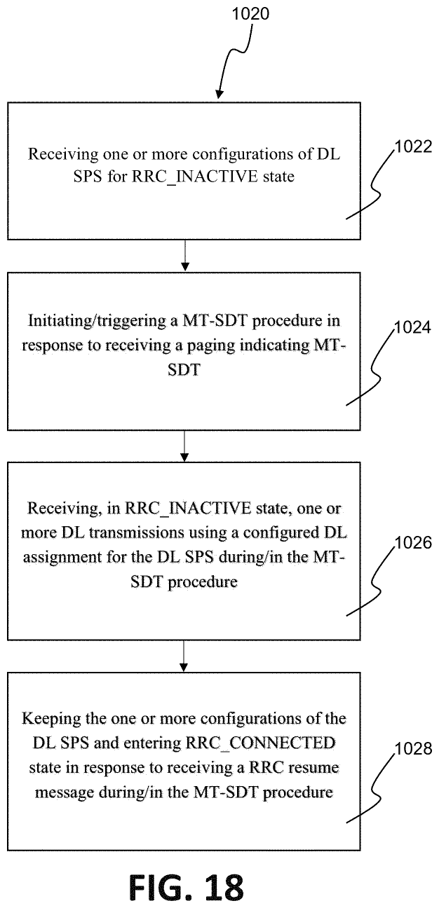

Referring to FIG. 18, with this and other concepts, systems, and methods of the present invention, a method 1020 for a UE in a wireless communication system comprises receiving one or more configurations of DL SPS for RRC_INACTIVE state (step 1022), initiating/triggering a MT-SDT procedure in response to receiving a paging indicating MT-SDT (step 1024), receiving, in RRC_INACTIVE state, one or more DL transmissions using a configured DL assignment for the DL SPS during/in the MT-SDT procedure (step 1026), and keeping the one or more configurations of the DL SPS and entering RRC_CONNECTED state in response to receiving a RRC resume message during/in the MT-SDT procedure (step 1028).

In various embodiments, the method further comprises transmitting a RRC resume request message (e.g., RRCResumeRequest) using resources for a RA-SDT or a CG-SDT in response to initiating/triggering the MT-SDT procedure.

In various embodiments, the UE clears one or more configurations for the CG-SDT and the resources for the CG-SDT in response to receiving the RRC resume message.

In various embodiments, the configured DL assignment is provided by a PDCCH for activation of the DL SPS or by a RRC release message (e.g., RRCRelease).

In various embodiments, the one or more configurations of the DL SPS are received in a RRC release message (e.g., RRCRelease).

In various embodiments, the UE does not clear the configured DL assignment in response to receiving the RRC resume message (e.g., RRCResume).

In various embodiments, the UE clears the configured DL assignment in response to receiving the RRC resume message (e.g., RRCResume).

In various embodiments, the UE considers a Timing Advance (TA) timer as expired in response to receiving the RRC resume message (e.g., RRCResume).

For various embodiments, the UE may receive one or more configurations of DL SPS for RRC_INACTIVE state, e.g., in a RRC release message (e.g., RRCRelease). The UE may receive one or more configurations for CG-SDT and resources for the CG-SDT in the RRC release message (e.g., RRCRelease). The NW may transmit a paging (e.g., paging message) to indicate a MT-SDT procedure in RRC_INACTIVE state. In response to receiving the paging (e.g., paging message) indicating MT-SDT, the UE may initiate/trigger a (MT-)SDT procedure. In response to initiating/triggering the (MT-)SDT procedure, the UE may transmit a RRC resume request message (e.g., RRCResumeRequest) using resources for RA-SDT or CG-SDT. During/In the (MT-)SDT procedure, the UE may receive one or more DL transmissions using a configured DL assignment for the DL SPS. The configured DL assignment may be provided by a PDCCH for activation of the DL SPS or by a RRC release message (e.g., RRCRelease). The NW may transmit a RRC message to end the (MT-)SDT procedure. The NW may transmit a RRC resume message (e.g., RRCResume) to the UE. In response to receiving the RRC resume message (e.g., RRCResume) during/in the (MT-)SDT procedure, the UE may clear one or more configurations for the CG-SDT and the resources for the CG-SDT. In response to receiving the RRC resume message (e.g., RRCResume) during/in the (MT-)SDT procedure, the UE may keep the one or more configurations of the DL SPS. In response to receiving the RRC resume message (e.g., RRCResume) during/in the (MT-)SDT procedure, the UE may not clear the configured DL assignment. In response to receiving the RRC resume message (e.g., RRCResume) during/in the (MT-)SDT procedure, the UE may consider a TA timer as expired. In response to receiving the RRC resume message (e.g., RRCResume) during/in the (MT-)SDT procedure, the UE may enter RRC_CONNECTED state.

Referring back to FIGS. 3 and 4, in one or more embodiments from the perspective of a UE, the device 300 includes a program code 312 stored in memory 310 of the transmitter. The CPU 308 could execute program code 312 to: (i) receive one or more configurations of DL SPS for RRC_INACTIVE state; (ii) initiate/trigger a MT-SDT procedure in response to receiving a paging indicating MT-SDT; (iii) receive, in RRC_INACTIVE state, one or more DL transmissions using a configured DL assignment for the DL SPS during/in the MT-SDT procedure; and (iv) keep the one or more configurations of the DL SPS and enter RRC_CONNECTED state in response to receiving a RRC resume message during/in the MT-SDT procedure. Moreover, the CPU 308 can execute the program code 312 to perform all of the described actions, steps, and methods described above, below, or otherwise herein.

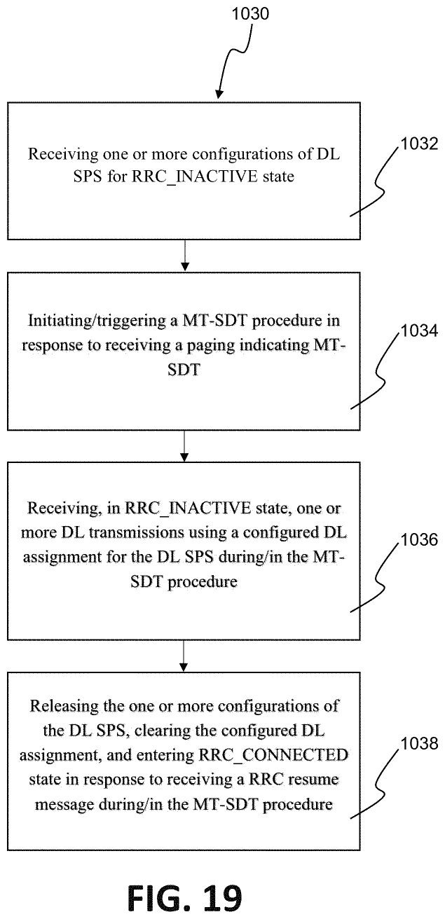

Referring to FIG. 19, with this and other concepts, systems, and methods of the present invention, a method 1030 for a UE in a wireless communication system comprises receiving one or more configurations of DL SPS for RRC_INACTIVE state (step 1032), initiating/triggering a MT-SDT procedure in response to receiving a paging indicating MT-SDT (step 1034), receiving, in RRC_INACTIVE state, one or more DL transmissions using a configured DL assignment for the DL SPS during/in the MT-SDT procedure (step 1036), and releasing the one or more configurations of the DL SPS, clearing the configured DL assignment, and entering RRC_CONNECTED state in response to receiving a RRC resume message during/in the MT-SDT procedure (step 1038).

In various embodiments, the method further includes transmitting a RRC resume request message (e.g., RRCResumeRequest) using resources for a RA-SDT or a CG-SDT in response to initiating/triggering the MT-SDT procedure.

In various embodiments, the UE clears one or more configurations for the CG-SDT and the resources for the CG-SDT in response to receiving the RRC resume message.

In various embodiments, the configured DL assignment is provided by a PDCCH for activation of the DL SPS or by a RRC release message (e.g., RRCRelease).

In various embodiments, the one or more configurations of the DL SPS are received in a RRC release message (e.g., RRCRelease).

For various embodiments, the UE may receive one or more configurations of DL SPS for RRC_INACTIVE state, e.g., in a RRC release message (e.g., RRCRelease). The UE may receive one or more configurations for CG-SDT and resources for the CG-SDT in the RRC release message (e.g., RRCRelease). The NW may transmit a paging (e.g., paging message) to indicate a MT-SDT procedure in RRC_INACTIVE state. In response to receiving the paging (e.g., paging message) indicating MT-SDT, the UE may initiate/trigger a (MT-)SDT procedure. In response to initiating/triggering the (MT-)SDT procedure, the UE may transmit a RRC resume request message (e.g., RRCResumeRequest) using resources for RA-SDT or CG-SDT. During/In the (MT-)SDT procedure, the UE may receive one or more DL transmissions using a configured DL assignment for the DL SPS. The configured DL assignment may be provided by a PDCCH for activation of the DL SPS or by a RRC release message (e.g., RRCRelease). The NW may transmit a RRC message to end the (MT-)SDT procedure. The NW may transmit a RRC resume message (e.g., RRCResume) to the UE. In response to receiving the RRC resume message (e.g., RRCResume) during/in the (MT-)SDT procedure, the UE may clear one or more configurations for the CG-SDT and the resources for the CG-SDT. In response to receiving the RRC resume message (e.g., RRCResume) during/in the (MT-)SDT procedure, the UE may release the one or more configurations of the DL SPS and/or clear the configured DL assignment. In response to receiving the RRC resume message (e.g., RRCResume) during/in the (MT-)SDT procedure, the UE may enter RRC_CONNECTED state.

Referring back to FIGS. 3 and 4, in one or more embodiments from the perspective of a UE, the device 300 includes a program code 312 stored in memory 310 of the transmitter. The CPU 308 could execute program code 312 to: (i) receive one or more configurations of DL SPS for RRC_INACTIVE state; (ii) initiate/trigger a MT-SDT procedure in response to receiving a paging indicating MT-SDT; (iii) receive, in RRC_INACTIVE state, one or more DL transmissions using a configured DL assignment for the DL SPS during/in the MT-SDT procedure; and (iv) release the one or more configurations of the DL SPS, clear the configured DL assignment, and enter RRC_CONNECTED state in response to receiving a RRC resume message during/in the MT-SDT procedure,. Moreover, the CPU 308 can execute the program code 312 to perform all of the described actions, steps, and methods described above, below, or otherwise herein.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a User Equipment (UE), comprising:
receiving one or more configurations of Downlink (DL) Semi-Persistent Scheduling (SPS) for Radio Resource Control Inactive (RRC_INACTIVE) state;
initiating a Mobile Terminated Small Data Transmission (MT-SDT) procedure in response to receiving a paging indicating MT-SDT;
receiving, in RRC_INACTIVE state, one or more DL transmissions using a configured DL assignment for the DL SPS during the MT-SDT procedure; and
keeping the one or more configurations of the DL SPS and entering RRC_CONNECTED state in response to receiving a RRC resume message during the MT-SDT procedure.

2. The method of claim 1, further comprising transmitting a RRC resume request message using resources for a Random Access-based SDT (RA-SDT) or a Configured Grant-based SDT (CG-SDT) in response to initiating the MT-SDT procedure.

3. The method of claim 2, wherein the UE clears one or more configurations for the CG-SDT and the resources for the CG-SDT in response to receiving the RRC resume message.

4. The method of claim 1, wherein the configured DL assignment is provided by a Physical Downlink Control Channel (PDCCH) for activation of the DL SPS or by a RRC release message.

5. The method of claim 1, wherein the one or more configurations of the DL SPS are received in a RRC release message.

6. The method of claim 1, wherein the UE does not clear the configured DL assignment in response to receiving the RRC resume message.

7. The method of claim 1, wherein the UE clears the configured DL assignment in response to receiving the RRC resume message.

8. The method of claim 1, wherein the UE considers a Timing Advance (TA) timer as expired in response to receiving the RRC resume message.

9. A method for a User Equipment (UE), comprising:
receiving one or more configurations of Downlink (DL) Semi-Persistent Scheduling (SPS) for Radio Resource Control Inactive (RRC_INACTIVE) state;
initiating a Mobile Terminated Small Data Transmission (MT-SDT) procedure in response to receiving a paging indicating MT-SDT;
receiving, in RRC_INACTIVE state, one or more DL transmissions using a configured DL assignment for the DL SPS during the MT-SDT procedure; and
releasing the one or more configurations of the DL SPS, clearing the configured DL assignment, and entering RRC_CONNECTED state in response to receiving a RRC resume message during the MT-SDT procedure.

10. The method of claim 9, further comprising transmitting a RRC resume request message using resources for a Random Access-based SDT (RA-SDT) or a Configured Grant-based SDT (CG-SDT) in response to initiating the MT-SDT procedure.

11. The method of claim 10, wherein the UE clears one or more configurations for the CG-SDT and the resources for the CG-SDT in response to receiving the RRC resume message.

12. The method of claim 9, wherein the configured DL assignment is provided by a Physical Downlink Control Channel (PDCCH) for activation of the DL SPS or by a RRC release message.

13. The method of claim 9, wherein the one or more configurations of the DL SPS are received in a RRC release message.

14. A User Equipment (UE), comprising:
a memory; and
a processor operatively coupled to the memory, wherein the processor is configured to execute program code to:
receive one or more configurations of Downlink (DL) Semi-Persistent Scheduling (SPS) for RRC_INACTIVE state;
initiate a Mobile Terminated Small Data Transmission (MT-SDT) procedure in response to receiving a paging indicating MT-SDT;
receive, in Radio Resource Control Inactive (RRC_INACTIVE) state, one or more DL transmissions using a configured DL assignment for the DL SPS during the MT-SDT procedure; and
keep the one or more configurations of the DL SPS and entering RRC_CONNECTED state in response to receiving a RRC resume message during the MT-SDT procedure.

15. The UE of claim 14, wherein the processor is further configured to execute program code to transmit a RRC resume request message using resources for a Random Access-based SDT (RA-SDT) or a Configured Grant-based SDT (CG-SDT) in response to initiating the MT-SDT procedure.

16. The UE of claim 15, wherein the UE clears one or more configurations for the CG-SDT and the resources for the CG-SDT in response to receiving the RRC resume message.

17. The UE of claim 14, wherein the configured DL assignment is provided by a Physical Downlink Control Channel (PDCCH) for activation of the DL SPS or by a RRC release message.

18. The UE of claim 14, wherein the one or more configurations of the DL SPS are received in a RRC release message.

19. The UE of claim 14, wherein the UE does not clear the configured DL assignment in response to receiving the RRC resume message.

20. The UE of claim 14, wherein the UE clears the configured DL assignment in response to receiving the RRC resume message and/or the UE considers a Timing Advance (TA) timer as expired in response to receiving the RRC resume message.
